(19) United States
(12) Patent Application Publication
(10) Pub. No.: US 2007/0220565 A1
(43) Pub. Date: Sep. 20, 2007

(54) Inventory Control With Content Cache, Time Scarcity Marker and Merchandising Incentives for Transactional Shopping Video On Demand Cable Systems

(76) Inventors: Albert J. Angel, N Miami Beach, FL (US); Terry S. Bienstock, Miami Beach, FL (US); Barry Leeper, Deerfield Beach, FL (US); Gary A. Weiner, Miami Beach, FL (US); Lance Eisenberg, Miami, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/556,742

(22) Filed: Nov. 6, 2006

Related U.S. Application Data
(60) Provisional application No. 60/733,499, filed on Nov. 4, 2005.
(60) Provisional application No. 60/733,502, filed on Nov. 4, 2005.
(60) Provisional application No. 60/733,724, filed on Nov. 4, 2005.
(60) Provisional application No. 60/733,895, filed on Nov. 4, 2005.
(60) Provisional application No. 60/733,948, filed on Nov. 4, 2005.
(60) Provisional application No. 60/733,949, filed on Nov. 4, 2005.
(60) Provisional application No. 60/733,984, filed on Nov. 4, 2005.

(51) Int. Cl. H04N 7/173

(52) U.S. Cl. 725/87; 725/86; 725/91; 725/93; 725/114

(57) ABSTRACT

The inventory tracking and purchasing method is deployed VOD interactive TV (STB-TV). Goods advertised with the shop on-demand (OD) process and the shop OD server, via the cable head end (HE) transmits an inventory sales indicator as metadata or configured VA to the STB-TV. The shop OD process displays the inventory scarcity indicia to the user. The shop OD server tracks goods available for sale based upon vendor supplied data or fictitious merchandising efforts. The sales indicator may be a time countdown to sell the goods. The time countdown is clock-based (STB) or metadata or VOD asset-based. Discount coupons may be sent as metadata or VA. The discount, time count and inventory scarcity indicator may be independent.

The present application is a regular patent application based upon and claiming the benefit of provisional patent applications Ser. Nos. 60/733,499; 60/733,502; 60/733,724; 60/733,895; 60/733,948; 60/733,949 and 60/733,984, all filed on Nov. 4, 2005, per 35 U.S.C. 119(e)(3).

The present invention relates to one or more systems permitting a user/viewer to purchase goods and services (which may be digital, entertainment content or other goods or services delivered to the user's home, business, computer, cell phone, pda, etc.) via his or her's cable enabled interactive television set (more precisely, the set top box STB on the TV or a cable ready TV or TV with PCI cable card therein). Several processes, systems and sub-systems are described herein. Some systems/sub-systems may be combined together or, alternatively, may be separate systems that are employed as needed. The value and inventiveness of the present systems are not the general application of shopping on television coupled with video on-demand (VOD) features, but a more specific application of shopping employing existing video on-demand infrastructure and STB VOD applications. That is, on demand or OD shopping experience employs into existing VOD applications, wherein the user-viewer buys a real-world goods or services via the VOD-world content-purchase transaction models described and claimed herein operable on existing the VOD system.

### BACKGROUND

A cable plant's existing VOD system typically includes head end HE-based VOD Asset Management Systems—AMS, HE-based VOD content storage systems, such as HE-based VOD content pumps, and HE-based VOD Business Management Systems—BMS. Further, the head end HE distributes STB-based VOD client applications to STB's at the user-viewer's location, which usually includes an STB-based program guide. These VOD systems and software are employed, with little or no modification, to provide many of the basic functions of the shopping experience described herein. This approach is different from previous television-based shopping applications, which utilize specially-built systems that do not seamlessly integrate into the cable infrastructure and the user experience, as the present invention does.

Prior art cable VOD systems and shopping systems have been proposed, and sometimes deployed, by Liberate (now TVWorks), WebTV, AOLTV, CommerceTV, OpenTV, Cable & Wireless, Gotuit, etc. Other ITV shopping applications are available.

FIG. 1 diagrammatically illustrates prior art video on demand system.

Currently, users, sometimes called herein subscribers or viewers, can select and watch video content, that is, audio visual entertainment services which are called “video on-demand” or “VOD”. VOD assets, or video assets (VAs) are streamed in a downloading session to the user-viewer's STB and the VA is displayed on the user's interactive TV set or monitor. The interactive TV is an STB-enabled TV. The user selects a video asset or video content by pointing a remote control (device 18) at the subscriber's set top box (STB) 12 after navigation through a list of on-screen menus.

The video content served by VOD systems usually consists of a selection of movies, TV shows, music videos, sporting events, news programs, and long-form advertisements. The on-screen VOD menus provide useful information about the available video content, such as its title, description, rating, run time, jacket or poster art, creation date, cost to watch, etc. Together, this video-content-related information is called VOD metadata, and its form has been somewhat standardized by the cable industry group CableLabs under a series of specifications called Asset Description Information (ADI). This VOD data is sometimes referred to herein as “VOD metadata.” The sum of VOD metadata in a particular system that describes all of the available video assets is called the “asset catalog.”

A VOD-client application program runs on the user's STB in order to present the user with the VA asset catalog in onscreen menus, enable user navigation of the menus, complete content rental transactions (i.e., purchase transactions), initiate and terminate video content being streamed from the HE-based VOD servers, and enable trick-play (i.e., fast-forward, rewind, pause) of the video content. In some cable systems, the VOD-client application program and the Electronic Program Guide (EPG) application program are tightly integrated and exist as one seamless application; in other cable systems the VOD-client and the EPG exist as separate applications, and may have a different look-and-feel. Herein, the STB-based application program that provides the functionality described above (e.g., asset catalog presentation, complete purchase transactions, initiate and terminate assets plays, enable trick-play, etc.) is sometimes referred to as the “VOD client.”

The VOD-client communicates with several servers located in the local or regional HE. These servers and the software applications thereon include the VOD Business Management System (“BMS”), the VOD video server (“VOD server” or “video pump”), and the VOD Asset Management System (“AMS”). The BMS handles all the “back-office” activities related to VOD asset plays. These HE-based activities include: initiating and terminating stream sessions; setting up session-based encryption services; asset identifier translation; purchase transaction services for VA play on demand or PPV; communication with billing and Operation Support System (“OSS”) servers; data logging; etc. The VOD server handles actual streaming of VOD video assets. It fetches digital video (which includes multiplexed digital audio) from the large-capacity Video Content Store (usually local hard disk arrays, or sometimes remote hard disks array connected via high-capacity, low-latency network connections) and streams it out to STBs through the cable system's Hybrid Fiber-Coax (HFC) access network. The VOD server is also responsible for handling the STB's VOD content trick-play requests and usage logging. The VOD server and the Video Content Store are sometimes integrated into the same equipment; other times they exist as different equipment connected via high-capacity, low latency network links. The AMS is responsible for managing the entire VOD content life cycle. With respect to VOD content (which is really a full VOD content package, composed of VOD video assets, VOD metadata, and other digital assets), the AMS ingests it into the Video Content Store, tracks it, controls access to it, maintains security, keeps its status, and ultimately deletes it.

Current business plans appear to adhere to the view that, when designing new applications for the iTV/VOD systems, the STBs will remain “dumb,” requiring as little state-and-processing on the STB as possible. The “smart” or vast majority of the processing should take place on the HE server, in a specially designed server application. This arrangement works quite well in digital cable environments because there is a relatively fast, stable communications link between the STBs and HE-based servers. Therefore the present inventions limit STB processing while maximizing the STB-HE communications link and the processing and memory available at the cable HE.

FIG. 1 diagrammatically illustrates a prior art, cable system MSO, that is, a multiple system operator (MSO). The local cable head end HE 20 is connected to a plurality of subscribers, subscribers A-D, etc., each subscriber having a set top box STB12. A single subscriber may have multiple STBs. The STB has a “MAC” address which uniquely identifies the STB to the cable HE 20.

The set top box 12 decodes the cable TV signals sent from the HE 20. In general, Video assets or VAs are streamed and played in real time without storage in the STB although some STBs have internal hard drives which may store VAs in a store and forward operation. The video content or video asset is played on TV display screen 14 under the control of a user control remote 18. In general, video content is delivered to the local cable head end 20 through various communications channels known to skilled persons in the art (e.g., from VA supplier 36, satellite delivery system 28, control communications station 38, regional cable station 40, internet or alternative communications network 30, land line system 32 and local intranet system or WAN 34 wireless or microwave networks or via terrestrial radio-frequency broadcast). In any event, the video content from video asset supplier station 36 is delivered to the cable head end 20 and particularly the head end server video storage and supplied to the STB via video pump or other VA delivery systems known in the art.

The other ways VA content may be distributed include: (a) “local ingest,” where locally-generated VA content (e.g. a local high-school football game, or local newscast) is encoded and ingested into VA broadcast to a large number of subscribers at the HE itself, (b) “terrestrial pitch,” where, instead of using satellites, the digital content is transferred over terrestrial datalinks; (c) “broadcast ingest” where regular broadcasted VA content from any of various networks is ingested into the VOD servers for later play-out (this often includes the broadcasted content first being transcoded or “rate-shaped” so that it conforms to the content bit-rate and format requirements imposed by the VOD servers).

There are two very different types of VAs used throughout VOD systems: Broadcasted VAs and on-demand VAs. Broadcast VAs are streamed to all set-tops within one or more hubs. Broadcasted VAs are used for a variety of purposes: background for the VOD client menus (which may or may not have overlay graphics to simulate “windows” of video content); a barker video in a scaled-window; transfer multiplexed data to STBs; provide VOD asset previews; etc. These VA assets may be broadcasted by the VOD servers, or specialized equipment that loops a video asset, and may be broadcasted from the local HE, or from a central location and carried to local HEs via satellites or terrestrial communication networks. Most VOD clients (at the STBs) will use broadcasted VAs throughout most of the presentation of the asset catalog, though a few will use 100% On-demand VAs for this purpose.

On-demand VAs are streamed to a single STB by the VOD server. On-demand VAs files are part of what is commonly known as a “VOD package,” composed of digital video content, digital audio content, and/or the metadata that describes it—defined by CableLabs in the ADI specifications. VOD packages are ingested into the VOD AMS, and streamed by the VOD server to a STB when the client initiates a play request (called a session set-up request, followed by a stream request—this is part of the DSM-CC User-to-User protocol.) When users watch on-demand content (e.g., a movie, or in the case of Shop OD the actual asset that invokes a purchase transaction), they are watching an On-demand VA being streamed from either the central HE, local HE, or possibly a hub—wherever the VOD server resides.

With respect to the VRN or video rich navigation, VRN is just one application of the EPG/VOD platform. There are many other EPG/VOD platforms, such as Scientific Atlanta's XOD, Pioneer's ShowRunner, GuideWorks' iGuide, Time Warner's Mystro Digital Navigator, Gotuit's Gotuit On Demand application, SeaChange/DVA's VODlink, and others from TVWorks/MetaTV, Navic, Concurrent, nCube, BlueStreak, etc. These all provide VOD-client application functionality that could be used as the basis for the Shop OD system. Herein, when a discussion involves the use of VRN as a platform, persons of ordinary skill in the art recognize that these functions can be implemented into other VOD/EPG client application/platforms.

Herein, VA streams are different than downloaded data and information. Streaming can be broadcast, multicast, or unicast, the latter being called on-demand streaming or On-Demand VOD delivered assets. Currently, systems do not stream separate video for each on-screen button area. There is only a single video stream with all the video assets pre-composited into that one video. The set-top STB uses an overlay graphic that has transparent areas which show-through to the video beneath. In this way, it appears to the user-viewer that the system is playing separate videos, however, it is really one video beneath, with a graphics overlay that has separate windows showing through to the one video.

### OBJECTS OF THE INVENTION

It is an object of the present invention to provide an inventory tracking and purchasing method which permits a user-viewer to participate in a purchasing program via the user's interactive television set as part of a shop on-demand (OD) process.

It is another object of the present invention to provide an inventory sales indicator when goods and services are advertised on the VOD to the user-viewer wherein the inventory sales indicator is based upon VOD menu metadata, VOD asset metadata, a VOD asset from the cable head end for a VOD asset from the shop OD client application operative at the cable head end.

It is a further object of the present invention to provide a tracking of goods or services subject to the shop OD computer server wherein the inventory sales indicator is either an actual or a ficticious inventory level indicator. Just in inventory controls linking the buyer, the shop OD server and the vendor are provided herein.

It is a further object of the present invention to provide an actual or a ficticious time clock display during the advertising of the goods or services on the user's VOD interactive television set based either upon a clock in the interactive television set (preferably the STB) or based upon a time formative signal.

It is a further object of the present invention to generate the inventory scarcity time countdown indicia based upon an inventory countdown indicator as an inventory formative signal.

It is an additional object of the present invention to provide a discount coupon which is part of a discount formative signals generated from the VOD menu metadata, or VOD asset metadata.

### SUMMARY

The inventory tracking and purchasing method is deployed on a VOD interactive television set. Goods and services are advertised upon command of the user-viewer. The system transmits an inventory sales indicator as a formative signal which may be a VOD menu metadata, VOD asset metadata, VOD asset from the cable head end or VOD asset from a shop on-demand client application. The system effects the display of the inventory scarcity indicia with the advertising. The inventory scarcity indicia is associated with a plurality of tracked goods or services which tracked goods or services are monitored on the shop OD computer server. The inventory sales indicator may be based upon vendor supplied data or may be a ficticious merchandising incentive. The inventory sales indicator may be linked to a time countdown where the time countdown may be independent of the inventory sales indicator. If independent, the time countdown is based upon either clock signal from the interactive television set or based upon metadata or VOD assets. Also, optionally or in addition to, a discount coupon may be sent with the metadata or VOD asset. If the discount coupon is independent of the inventory sales indicator and time countdown, a discount coupon is based upon discount formative signals embodied as metadata.

### Abbreviations

In the drawings, and sometimes in the specification, reference is made to certain abbreviations. The following Abbreviations Table provides a correspondence between the abbreviations and the item or feature.
ADI Asset Description Information, typically VOD metadata
AMS Asset Management Systems, typically, VOD Asset Management Systems operate with HE-based VOD content storage systems, such as HE-based VOD content pumps
BMS Business Management Systems, typically HE-based VOD Business Management Systems which enable the HE application to process commercial transactions in conjunction with the user-viewer (among others). The BMS handles all the back-office activities related to VOD asset plays
Cable HE cable head end operated by a cable MSO, typically the source of video assets sent to a subscriber's set top box STB
Cable MSOs cable multi-system operator
cable-ready tuners for example, TVs with “cable-ready” tuners integrated therein which can connect direct to the cable output in the home, business, etc.
COM or cmd command
Comm communications
Comp Sys computer system
DBS direct broadcast satellite systems, usually one-way communications or systems with very limited back channel communications features, for example, DirectTV, Echostar; WebTV, TiVo
EPG Electronic Program Guide is a VOD client application program operable on the STB
Id identity data
IPTV internet protocol TV television
ITV interactive TV
GD Guide Directory
Mem memory
OD On Demand, such as Shop “On Demand” or Shop OD, enabling user or viewer to select, shop or view at a time of their own choosing
PC personal computer, laptop, hand-held computer
PCI “CableCard” peripheral component interconnect card for PC, especially a PCI which can connect direct to the cable output in the home, business, etc.
PDA personal digital assistant
Ph phone

PPV pay per view

push-VOD VA sent to STBs, typically specifically ordered by the user-viewer
PVR devices personal video recorders or DVRs, currently storing VAs on hard drives in the STBs
Sel select
Shop OD shop on demand using the described systems or sub-systems
SMS short message system, usually text message via cell phone
STB set top box
Sub'r, or sub subscriber or viewer
Supple comm supplemental communications channels are non-VOD enabled communications channels such as cellular telephone communications networks, a voice over internet protocol (VoIP), a terrestrial land-line telephone networks (fax, voice, call center-enabled communications and IVR), global computer communications network (Internet)
Sys system
User subscriber or viewer
VA or Vid Asset VOD video asset or VOD asset—any type of audio-video content, default screen, ad, infomercial, movie, sitcom, news broadcast
VOD video on demand
VOD asset catalog sum of VOD metadata in a particular system that describes all of the available video assets
VOD client applications Software operable on the STB which interacts with applications server software on the HE to achieve certain functions.
VOD metadata video-content-related information carried with or otherwise associated with the streaming download of VA. A cable industry group, CableLabs, has issued a series of specifications called Asset Description Information (ADI)
VOD video server a system on the HE which delivers VA to the STB, sometimes called
VOD server or video pump
VRN video rich navigation

### BRIEF DESCRIPTION OF THE DRAWINGS

Further objects and advantages of the present invention are found and discussed in the detailed description of the preferred embodiments taken in conjunction with the accompanying drawings in which:

FIG. 1 diagrammatically illustrates a prior art video on demand system.

FIG. 2 shows a new directory guide or Guide Directory for the Shop On Demand (“Shop OD”) navigational guide, shopper guide tool, selection process and transaction system.

FIGS. 3a, 3b, 3c and 3d diagrammatically illustrate the new multiple channel user interaction system invention which provides user enrollment features utilizing multiple communications channels, purchase confirmation transactional system. FIG. 3a shows a new Shop On Demand or Shop “OD” basic routine. FIG. 3b shows the continuation of path A of the new Shop OD routine. FIG. 3c is a continuation of path B which is “not a member” path from step 104, FIG. 3a. FIG. 3d shows general process flow chart showing one methodology of the new Shop OD goods or services purchased by a registered subscriber-user.

FIG. 4a shows a user set purchase control routine for a new video Shop on demand (Shop OD) cable system.

FIG. 4b is a continuation of FIG. 4a which notifies the user of the pin prefix A, B, C or D via the selected communications channel.

FIG. 4c shows a process for purchase acknowledgment via supplemental communications channels.

FIG. 5 is a prior art PPV system.

FIG. 6 shows a new offline parental control and preferred delivery and preferred user communications path system for a video on demand cable system.

FIG. 7a shows a new video archive, search and delivery system for video on demand cable system.

FIG. 7b shows a time countdown or fresh stamp and complementary goods for Shop OD goods and services.

FIG. 8 shows a video feedback product rating or shopping list comment system for video on demand cable system. The user can employ the feedback system to add comments for his or her shopping list.

FIG. 9 shows a new real time data tracker for video on demand purchase.

### GENERAL SYSTEM AND METHOD OR PROCESS COMMENTS

It is important to know that the embodiments illustrated herein and described herein are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views. The section titles are not meant to limit the detailed description of the system and process described therein.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system at the HE having separate elements or means for performing the individual functions or steps described or claimed or one or more elements or means combining the performance of any of the functions or steps disclosed or claimed, or may be arranged in a distributed computer system (the cable HE and shop OD client application thereat), interconnected by any suitable means as would be known by one of ordinary skill in the art. The shop OD server is communicatively coupled to the shop OD client application at the cable HE.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits. Furthermore, the computer readable medium may include computer readable information in a transitory state medium such as a network link and/or a network interface, including a wired network or a wireless network, that allow a computer to read such computer readable information.

The functional elements of the processes and computer programs described herein may be re-organized to optimize performance or comply with hardware limitations or interconnectivity with software platforms and master programs. In fact, the general descriptions and detailed descriptions employ the functional elements in different orders of operation.

### DETAILED DESCRIPTION OF THE EMBODIMENTS

The present invention relates to one or more systems permitting a user/viewer to purchase goods (which may be digital, entertainment content or other goods or services which may be subsequently delivered to the user's home, business, computer, cell phone, pda, etc.) via his or her cable enabled television set (more precisely, the set top box on the TV, TV monitor or integrated therein). Several systems and sub-systems are described herein. Some systems/sub-systems may be combined together or, alternatively, may be separate systems that are employed as needed.

A cable plant's existing VOD systems (e.g., HE-based VOD Asset Management Systems—AMS, HE-based VOD content storage systems, HE-based VOD content pumps, HE-based VOD Business Management Systems—BMS, STB-based VOD client applications, STB-based program guide) will be employed, with little or no modification, to provide many of the basic functions of the shopping experience described herein. This approach is markedly different from previous television-based shopping applications, which utilized specially-built systems that did not seamlessly integrate into the cable infrastructure and the user experience, as the present invention does.

Interactive Multi-Channel User Enrollment, Purchase Confirmation, and Fulfillment Response Transactional System for Video On Demand Cable Systems the Enrollment, Purchase Confirmation, Discount, Temp PIN Process in General

The interactive multi-channel user enrollment, purchase confirmation transactional system and purchase response feature is operative on video-on-demand (VOD) cable systems. The enrollment method permits a user-viewer to enroll in the shop on-demand purchasing program. Typically, a shop on-demand client application (software) is operative at the cable head end (on its VOD server and VOD system). Alternatively, software may be embedded on the systems at the cable head end itself. The difference being that the client application closely interacts with the shop on-demand server computer. One type of enrollment employs the interactive television set (the television with an STB) or the cable ready television or the television with a PCI cable card. Other methods of enrollment employ supplemental communications channels such as cellular telephone communications network, a voice over Internet protocol (VoIP), a terrestrial land-line telephone network and a global computer communications network, commonly called the Internet.

One methodology employs a discount when a non-enrolled user-viewer selects specific goods or services subject to a “buy-now” command. The system affects a display on the interactive television set showing a discount for these specific goods or services in addition to indicia prompting the non-enrolled viewer to employ at least one supplemental enrollment communications channel which includes cell phone, VoIP, land line or Internet to control the shop on-demand server and enroll. Alternatively, the user can enroll via the interactive television or STB. Partial enrollment may be possible via the STB but data input is difficult due to the user input controls on the STB remote.

A user-viewer profile data file or data structure is created which includes a preferential communications channel from the cell phone, VoIP, terrestrial land line and the Internet. The profile is stored on the shop OD server. The user may select one or more channel to create a prioritized list of communications channels he or she wants to supplement the shop on-demand program. In addition, the user profile data includes user selectable communications message format for a group of message formats including voice over cell phone, short message service SMS over the cell phone, text message over the cell phone, voice over a VoIP network, voice over terrestrial land line, facsimile (fax), and email over the Internet as well as a computer generated message directed to the user-viewer's computer enabled device (PDA, Black berry, etc.) over the Internet. The computer generated message is any generated electronic message from the shop on-demand computer server directed to the computer enabled device at the preferred location of the user-viewer.

The confirmation methodology is discussed below. The shop on-demand overall method and system permits the user-viewer to view and locate advertisements for goods or services and buy specific goods or services upon command of the user via the interactive television set (STB enabled TV) and cable head end. Typically, these ads are VA assets which are streamed to the user. Alternatively, or in addition thereto, text may be presented in menu formats discussed herein. In response to a buy now command by the viewer for specific goods or services, the buy now command is transmitted via the interactive television set to the cable head end. Preferably, this buy now command is sent to a shop on-demand client application program operative at the cable head end. This client application runs on the cable HE server. The shop on-demand computer server ultimately receives this buy now command along with a unique set identification (ID). The set ID code, in one embodiment, is the MAC code for the set top box STB. In response to the buy now command, a determination is made whether the user-viewer ID code (either the set ID code for the STD or other user ID code discussed later) matches an approved list of user-viewer ID codes either on the shop on-demand computer server or on a list stored at the cable head end. The list may be in the cable HE server, on the shop OD client application or on the shop OD server communicating with the cable HE server. The system confirms purchase of the specific goods or services via the interactive television set and cable head end and the shop-on-demand server. In one embodiment, the shop on-demand computer server activates the supplemental communications channel discussed above and communicates a supplemental confirmation notice to the user. Alternatively, or in addition to, the purchase is also confirmed locally by the shop on-demand computer server to the user-viewer interactive television set via the cable head end or from a shop on-demand client application operative on the cable head end. As is known in the art, a client application can run on the cable head end and the client application could be controlled or related to the shop on-demand computer server. The local confirmation indicator is a formative signal from the group of formative signals including a video-on-demand (VOD) menu metadata, a VOD asset metadata, a VOD asset from the cable head end or a VOD asset from the shop on-demand client application operable at the cable head end. In other words, the local confirmation indicator can be metadata downloaded as part of the VOD menu or metadata downloaded as part of a VOD asset or can be a VOD asset from the cable head end itself or VOD asset from the shop-on-demand client application which is operative at the cable head end. The shop OD confirm on a VA is inserted into the streaming on-demand VA to the user. The system also employs, in a preferred embodiment, a personal identification number (PIN) with the buy now command. The PIN is either a number, an alpha numeric data string or a character string which is kept secret by the user-viewer. Typically, the system requests either before or after the user selects the buy now button or menu element that the user input the PIN. The PIN is compared to pre-set PINs at the cable head end most likely on the shop on-demand computer server or stored in an approved list of user-viewers on the cable head end. The shop OD client application may have the list. If the set ID code is approved for the shop on-demand purchasing system and the PIN code is approved for the shopping system, the process purchases or affects the purchase of the specific goods ordered by the user and generates a specific goods order as well as the financial transactions request via the shop on-demand computer server. The order for the goods or services of course completes the transaction or affects the completion of the transaction and a financial transaction request involves instructions for the transfer of funds from the user-viewer (or authorized user-viewer party) to the seller of the goods or services. Order generation and financial transaction confirmation can be sent and most likely would be sent by the shop on-demand computer server to the user via the supplemental communications channel. Multiple communications may be initiated via the supplemental communications channels.

In the event the user-viewer does not have a PIN or is not enrolled at the time he or she makes the purchase via the shop on-demand purchasing program, a temporary PIN may be employed. Temporary PINs are assigned to a plurality of non-enrolled user-viewers which are communicatively coupled to the cable system network. The temporary PIN is linked to the unique user-viewer set ID code and this combination is processed by the shop on-demand computer server. Upon receipt of the buy now command and the specific goods/services order, as well as the temporary PIN, the shop-on-demand computer server activates an enrollment program prior to generating the specific goods or services order and prior to generating the financial transaction request. The enrollment process engages the supplemental communications network or channels. An aggressive enrollment process may be triggered if the specific goods or services exceed a predetermined amount, the inventory or the goods or services fall below predetermined amount or a predetermined time has passed. The aggressive enrolment process includes matching the user-viewer data available from a cable system with data from public or private databases in an effort to obtain enrollment data without significant user input and locate the user-viewer who is not enrolled on the shop on-demand purchasing system. The private or public databases may include on line telephone books, land ownership records, credit card records (private databases) and other information sources available to authorized commercial parties.

### Details of the Enrollment, Purchase Confirmation, Discount, Temp PIN Process

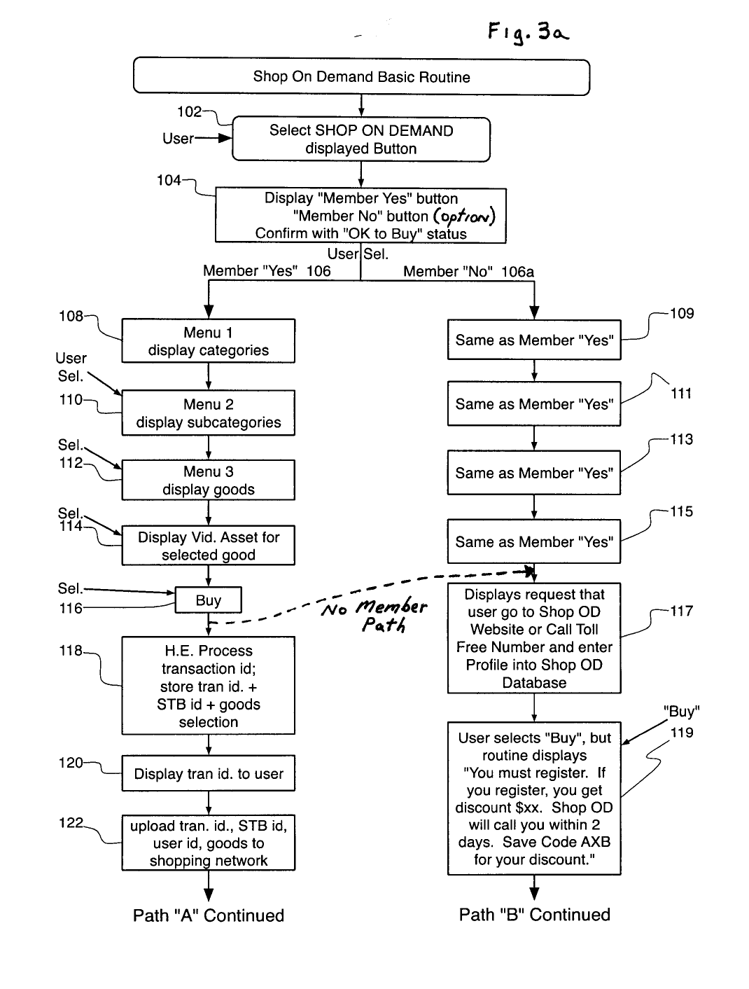

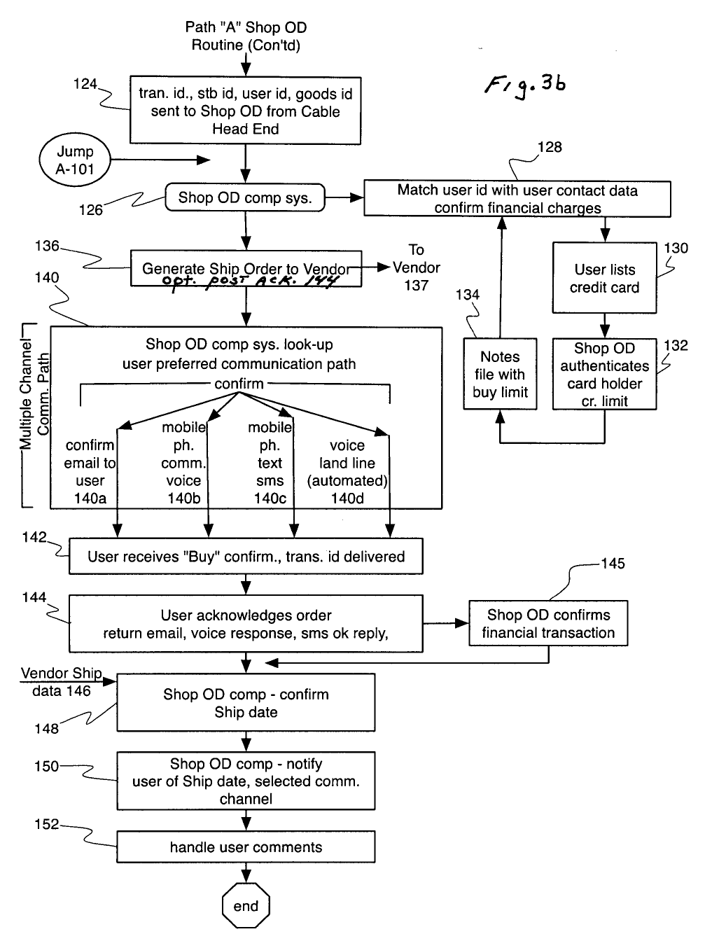

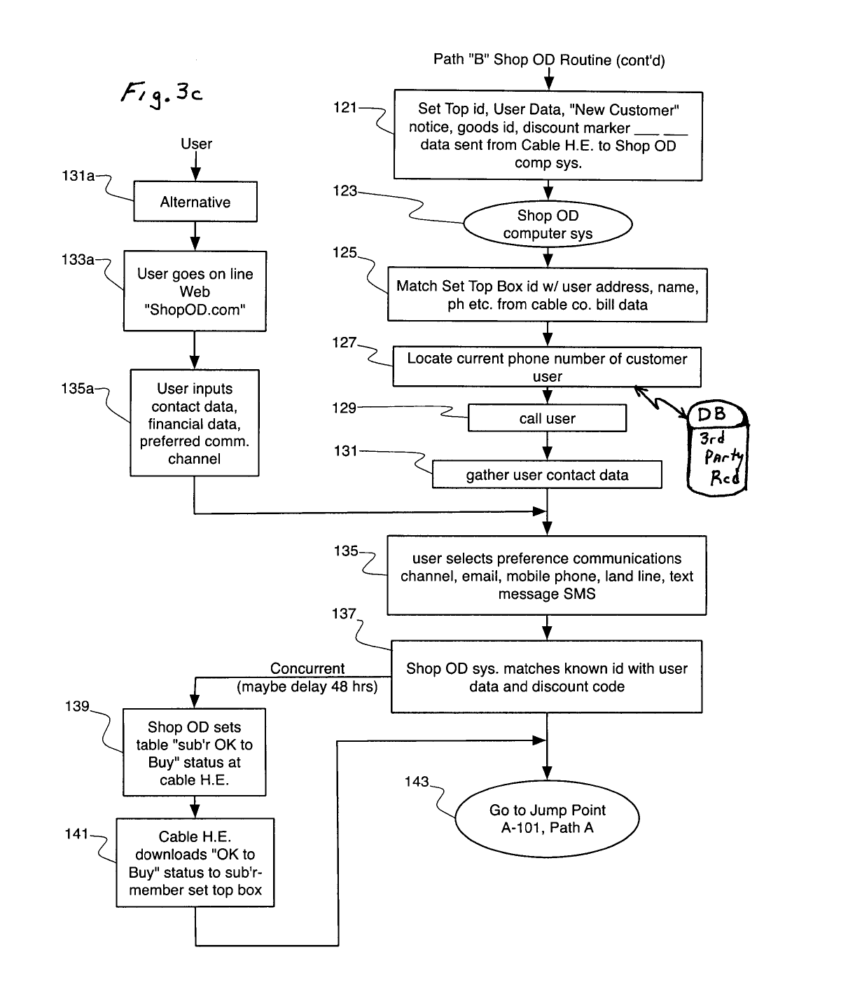

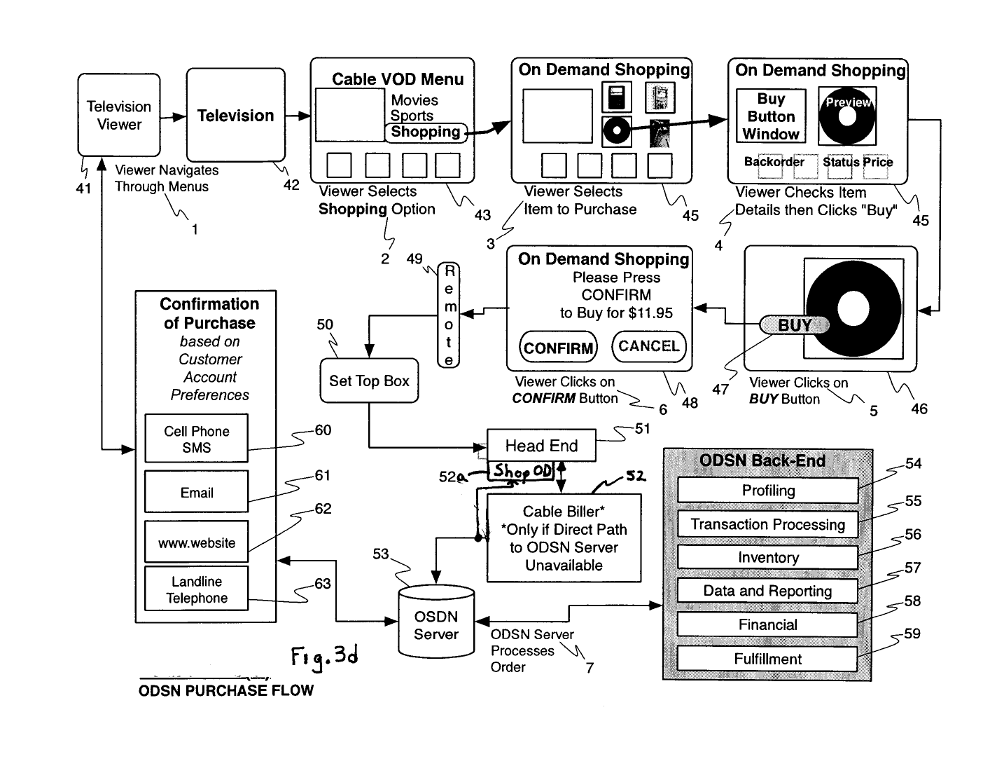

FIGS. 3a, 3b, 3c and 3d diagrammatically illustrate the multiple channel user interaction system invention which provides user enrollment features utilizing multiple communications channels, purchase confirmation transactional system and, in an enhanced system, fulfillment response features for shopping via video on demand cable systems. This new system enables the subscriber to (a) initially sign up with the Shop On Demand or Shop OD System and, more importantly, (b) to confirm, authorize or otherwise communicate with the Shop OD system after a purchase via the video on demand system. Multiple communications paths are provided, such as cell phone, text SMS message, Internet, email and voice-land line.

FIG. 3d shows a general process flow chart showing the Shop OD or buy VOD process. In addition to the foregoing, the user/viewer 41 may enroll in the Shop OD system via completely external supplemental communications channels such as by logging into the shopod.com website (independent or by prompting by mail ads, magazine ads, newspaper ads, or widely distributed voice interactions via a telephone or cell phone network), or by call center interactive user-profile data input, or by cell phone—internet interactive communications, or by other external enrollment processes not associated with the VOD—Shop OD system described herein. An inventory control system is also disclosed in FIG. 3d.

FIG. 3a shows a shop on demand or Shop “OD” basic routine. In step 102, the user selects “shop on demand” display button on his or her interactive television set by highlighting the displayed navigation “hot” button (or active textual link) with the remote control by enabling an associated “select” or “enter” button. The underlying data relative to the navigation button (a text frame or VA window) is typically streamed as an EPG Guide Directory to the STB. Step 104 displays the “member YES” button or “member NO” button to the user. The user should select whether he or she is already a pre-registered member of the shop on demand system. This selection keys the STB to display the next GD level.

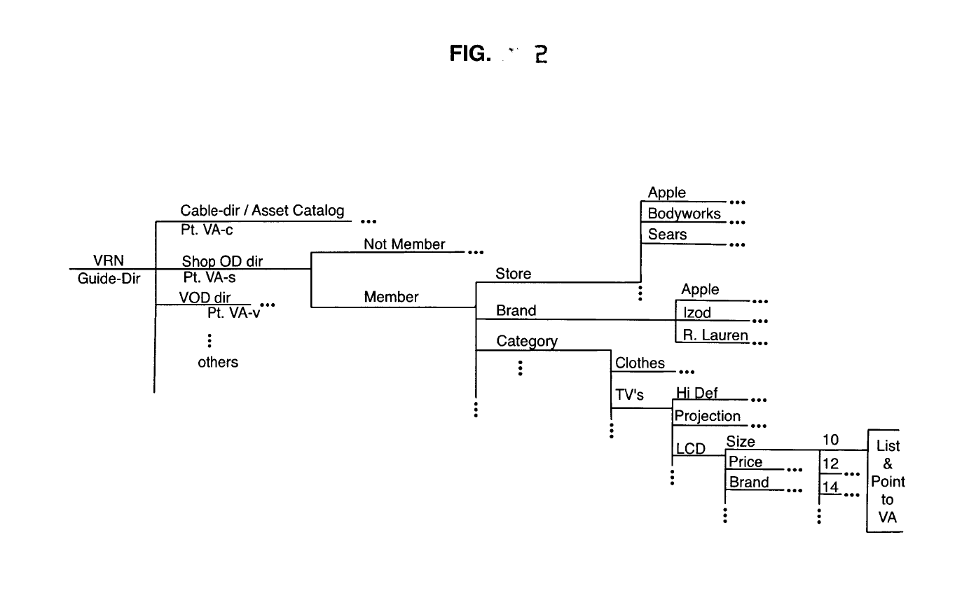

GD levels are graphically shown in FIG. 2.

By being a member, the user has previously registered with the Shop OD computer system. With the “member NO” button, the user may then be presented with a display which requests that the user go to the Shop OD website or call a toll free number and enter profile data into the Shop OD computer system. This “member no” option may be set up in order to prompt user registration, obtain proper contact info and act to limit fraudulent purchases, employing it as a default screen in the STB, much like a “no signal available” default screen. Other program routines may be used.

In addition to the foregoing, the user/viewer may enroll in the Shop OD system via completely external communications channels such as by logging into the shopod.com website (independent or by prompting by mail ads, email ads, cell phone data SMS—text message ads, magazine ads, newspaper ads, TV ads, or widely distributed voice interactions via a telephone or cell phone network), or by call center interactive user-profile data input, or by cell phone—internet interactive communications, or by other external enrollment processes not associated with the VOD—Shop OD system described herein.

The user-viewer, if not entering basic contact data via the shop OD or VOD process, may enroll as a member via the shop od.com website as prompted by ads, email contacts from mailing lists, telephone solicitation, etc.

With respect to MEMBER vs. NON-MEMBER processing, there are four basic operational systems or processes. Option A: The flow is vastly simplified if the front-end process doesn't care whether the user is a member or not—either way, the user's purchase request causes the user to be shown a valid transaction ID, or at least a spurious trans-ID that the Shop OD server recognizes as not being associated with a user-viewer via the set id code for the user-viewer STB. At the time of displaying the trans-id to the user, the user is told that if he/she is not already a Shop OD member with a credit card and address on file in a member profile, then he/she must write down the transaction ID and within a certain time (such as 48 hours) must go to the Shop OD website or call an 800 number to sign up for membership, provide credit card and address, etc against the transaction ID that was just provided. Basically, use the “spurious buy” routine detailed below is employed for all non-member transactions. This takes any member vs non-member differences completely out of the on-screen experience.

Option B: If the system actually needs to determine membership status within the on-screen purchase flow, then it may be possible for the Shop OD server to detect membership status and affect the purchase flow. This possibility hinges not on the speed of STB/server processing, but on how/when VRN and other VOD-client menu screens destined for an individual STB are allowed to be dynamically modified by the shop OD client application operative on the cable HE server or VA pump. The Shop OD client application must discover the transaction id or trans-id from the user sent by the user's STB to the cable HE. The Shop OD server can query the VOD system logs, determine membership based on the STB or MAC address, and change the VRN or VOD client menus such that a different path is taken for member vs. non-member. The VRN or other VOD-client application servers may allow for this dynamic sensing/change, that is, have APIs for the change, by menu modification by 3^{rd} party applications or servers. Enabling this dynamic menu modification on a per-STB basis is possible. The dynamic change could be menu modification, or simply VOD metadata modification within the AMS, as the menus are based upon such VOD metadata.

Option C: As described herein, the user needs to declare their membership status with an on-screen fork. The better placement of the member/non-member decision fork just before the purchase decision screen rather than as shown in the drawings. See optional “no member” path shown in dashed lines.

Option D: If the shopping system is more tightly integrated with the MSO's system, then user-subscriber billing and contact information can be obtained directly from the billing and subscriber management systems of the cable MSO. That is, instead of making the user sign up as a member to obtain credit card, shipping address, etc., this information may be obtained by querying the MSO systems that already have this information. In fact, the billing could be handled through the existing VOD payment mechanisms—no billing or credit card information would need to be obtained. This approach obviates the need for any member vs non-member processing differences, both in on-screen experience, but also avoids the necessity of signing up with the shop OD service. See FIG. 3d, block 52.

If the user selects the Member routine in FIG. 3a and tries to purchase goods/services, a spurious “buy order” is created and is subsequently handled as described herein. In the event a user selects “Member” when, in fact, that user is not a pre-registered Member of the Shop OD system, a spurious “buy” for goods may be registered. However, this spurious “buy” order will not be processed by the Shop OD system because the STB id sent with the buy order from the “not a member” user will not match the list of STB ids in the Shop OD master computer system (or on the Shop OD client application at the cable HE) and further the spurious buy order will cause the Shop OD computer system to initiate a communications event with the “not a member” viewer which will result in the viewer enrolling in the Shop OD program. Access to the cable MSO's client database, or limited portions thereof, may trigger enrollment via supplemental channels.

If the user in step 104 selects “member YES” the set top box confirms whether the user is registered as a Shop On Demand previous customer by comparing the STB id with the local cable head end registrant data (optional step—dependent upon STB and interconnectivity of VOD system). Alternatively, the GD may simply go to the next sub-directory and display items available for sale. Other enrollment confirmation systems are possible as described herein.

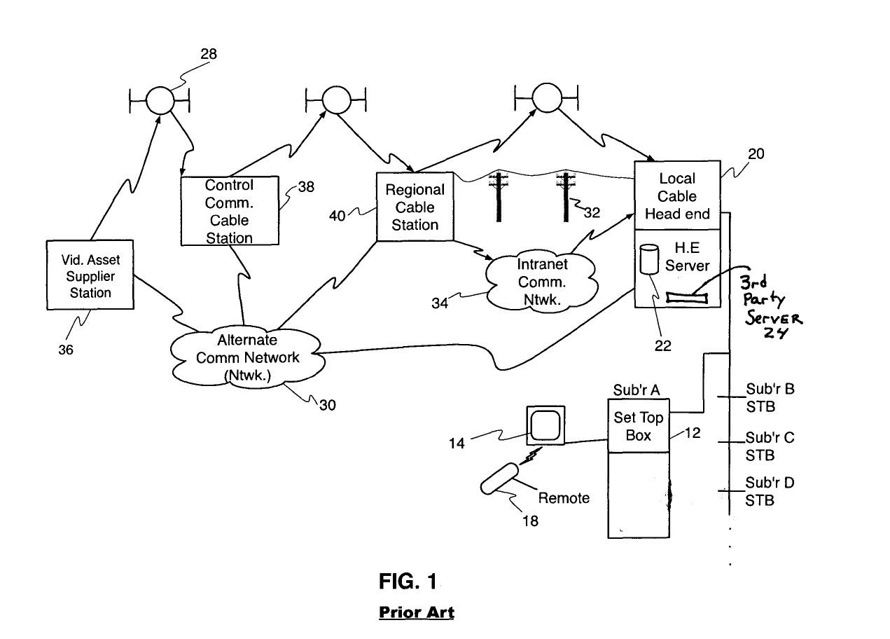

At the cable head end (or live from a central shop OD database), there is a file showing each subscriber and listing whether that subscriber has previously registered as a Shop on demand subscriber. The file may be stored at the cable HE or may by available via the Shop OD datacenter, utilizing user logs, billing records and accessed via a supplemental applications processor-computer at the cable HE. See FIG. 3d, shop OD client application 52a at head end 51. This third party server (FIG. 1, server 24) may be the Shop OD server for cable customers for that particular cable HE 51. Otherwise, a Shop OD client application 52a (FIG. 3d) may be deployed at cable HE 51.

This member file may be downloaded with the Shop OD Guide Directory and used to confirm membership and control access and purchases. This is operationally similar to the cable system wherein the user subscriber has been approved to receive a certain premium channel, such as HBO, but has not been approved to receive the other premium channels, such as ShowTime. When the user selects Showtime on the set top box STB (a text frame navigational display button) and the user has not been authorized to receive the Showtime premium channel, the STB generates a VOD command to the HE, the HE then checks to see if that service is provided to the user/viewer. If not, the HE sends a VA or metadata (maybe GD menu metadata) to the STB which causes display of a “Not Available” default screen to the user. In a similar manner, the Shop OD system may send the set top box of the subscriber with an “OK to buy” status data packet (sometimes called herein “data bit”) (possibly with the Shop OD GD as VOD metadata) which indicates that the subscriber associated with the set top box has been approved as a Shop OD customer. The system in step 106 and step 106A determines whether the user has selected member “YES” or member “NO” and may shuffle the STB (via VAs from the HE) to an alternate menu for non-member alternative options.

If not enrolled, the Shop OD system generates a spurious “buy order” when a non-preregistered member selects the “Member” subroutine and attempts to buy goods/services.

In addition, the STB GD menu screens may require the input of a user personal identification number PIN, or a household OPION or a master—override PIN prior to permitting the user/viewer to activate the Shop OD buying system. If PINs are used, after enrollment of the user with the Shop OD system, the PINs are checked at the HE prior to menu VA stream download into the STB.

As an initial or temporary PIN, if the user has not enrolled via phone (land-line or cell) or by computer (pda or PC), a temporary matching PIN may be part of the “non-member” Shop OD GD. This temporary pin may permit the user/viewer to buy one item (which may have a limited purchase price code—discussed herein) to permit a first time buyer to both (a) enroll in the Shop OD system and (b) buy goods/services.

In step 108 (FIG. 3a) and step 109, the Shop OD system displays a menu 1 which is GD text selection showing all the categories. For example, menu 1: automobile accessories, movie cameras, computer systems. Steps 110 and 111 show menu 2, which displays sub-categories as GD text menu buttons. If the user has selected audio systems, menu 2 may identify amplifiers, speakers, turn tables, CD players. In steps 112, 113, the menu 3 displays goods. If the user in the previous step has selected “speakers” then menu 3 would identify Bose, Acoustic Research, JBL, etc. Step 114, 115 displays the text buttons, and when the text buttons are selected by the user, the VA or video assets for selected goods. For example, if the user selected Bose speakers in previous steps 112, 113, the step 114, 115 would show all the VA details for that Bose speaker. In step 116, the user selects the “buy” button. In step 117, if the user selects the buy button, the set top box, by the operation of the Shop OD Guide Directory has already noted or registered that the “OK to buy” status bit is OFF or low. In other words, the directory path previously selected by the user tells the system that the user is NOT OK to BUY. Therefore, in step 117 when the user at 119 selects “buy” the set top box displays “You must register. If you register, you get a discount of $XX. Shop OD will call registrants within 2 days. Save code AXBY for your discount.” Of course, the GD text and/or VA (a navigational frame/window) displayed at step 117 could be completely different. Such as asking the prospective Shop OD customer to call and register with the Shop OD outside computer system. “Outside” refers to a computer system external to the VOD cable sub-system. After step 117, the two sub-routine branches (MEMBER YES or MEMBER NO branches) significantly change and after step 117, the path B is taken which leads to FIG. 3c. Substantially similar displays at steps 108-115 give the same shopping experience to members and non-members.

Returning to step 116, when the user selects “buy button,” the system in step 118 has the cable head end process the transaction ID, store the transaction ID and the set top box ID and the goods selection, with the GD directory item code. The transaction ID is a compilation and a mathematical algorithm of the set top box ID and the particular time, day, hour, minute and second of the buy purchase. A unique “trans id” enables the Shop OD external system to process the purchase unique to the user. This special transaction ID is then unique to the set top box ID and the goods selection. The trans ID may be created at the STB by an algorithm adding the STB set ID with date/time, then sent to the cable HE. Otherwise the trans ID can be created at the cable HE (or Shop OD client application) then sent to the STB as metadata or configured VA. In step 120, the transaction ID is downloaded to the user and displayed to the user for his or her further utilization (optional step, dependent upon interactivity of STB). Step 122 has the cable head end (HE) of the Shop OD application server upload the transaction ID, the set top box ID, the user contact data or user ID associated with the set top box ID that is, the customer name, address, phone number etc. stored by the cable head end or the cable operator, and the goods ID to the Shop OD network. Cable subscriber data maybe stored in the external Shop OD system and the cable HE may upload just the user id. The system then jumps to FIG. 3b which is the continuation of “member” path for the Shop OD routine.

FIG. 3b shows the continuation of path A of the Shop OD routine. In step 124, which occurs at the cable head end, the transaction ID, the set top box ID, user information associated with the set top box ID, sometimes called user ID, the goods ID is sent to the Shop OD system. The Shop OD system is coupled to a communications network to the local cable head end 20 shown in FIG. 3d. This communications link may be through a modem, a router through the internet or other communications system. The Shop OD computer system server external to HE 20 includes memory, processor and various communications modules. See FIG. 3d. It may also be coupled to a telephone call center. Alternatively, the Shop OD server may be the third party server 24 at the cable HE 20 in addition to VA server 22 in FIG. 1. OD client application 52a in FIG. 3d is linked to the external Shop OD system 53.

In step 126, the following occurs in the Shop OD computer system. In step 128, the user ID is matched with the user contact data. A confirmation of financial charge is made. In step 130, the user has listed one or more credit cards, debit cards, or other financial processes (automatic withdrawal) and an order of preference to finance a purchase. Other payment systems may be employed by the user/member such as debit cards, electronic payment plans (for example, direct withdrawal programs), electronic checks, etc. In step 132, the Shop OD authenticates the card holder, the credit limit and the authorization code form the credit card processor or payor.

Additional authorization sub-routines using supplemental communications channels may be employed such a (a) recording a voice authorization (optionally with voice recording or the YES, I AGREE to an interactive voice response inquiry form the Shop OD system); (b) multiple electronic communications (such as “Do you agree to this purchase” and user—electronic response, via text message or website confirm, or voice YES with interactive voice response, IVR); (c) completely independent communications systems such as an email to the user which requires an email YES or an email NO response (or other website approval/declination of the purchase).

Some type of authorization of the purchase may also be added to the Shop OD routine in FIG. 3b. This BUY authorization may be locally stored at the Shop OD client application (“App”) or be data uploaded to the Shop OD computer systems.

In step 134, the Shop OD computer notes the file with a buy limit, if a limit is indicated in the user contact database. This is an optional routine since the Shop OD system need not absolutely have a buy limit. Vendors may “waive” a Buy Limit routine for goods/services purchased by the users. For example, the user may order a pizza for home delivery and be required to pay the delivery person for the Shop OD purchase. No Buy Limit routine would be required in this purchase.

In any event, back to step 126 and the Shop OD computer system, step 136 generates a “ship goods” order to the vendor of the goods ordered VOD by the user-member. This is sent to the vendor in step 137. In step 140, the Shop OD computer system first looks up the preferred communications path associated with the user. At a previous time, the user has entered his or her contact data, name, address, phone number, cell phone number, email and also payment information. In addition, the user has identified their preferred communications path in order to confirm a particular “buy order” from the Shop OD computer system using the video on demand or VOD prior art system. Therefore, the multiple channel communications path 140 includes the concept that the buy order is confirmed with an email to the user step 140a, a mobile phone voice note or voice command step 140b, and mobile phone text sms short message service or text message step 140c or a voice prompt on the land line in step 140d. The voice notification to the user may be automated (computerized voice and response record) in steps 140b and 140d. Other types of communications links could be utilized to confirm the purchase order to the user-member. Further, the confirmation of the purchase order through multiple channel communications path 140 may occur prior to the “generate ship order” 136. In other words, the user may request, as part of the previously stored Shop OD profile, that he or she approves the purchase via some type of feedback mechanism, email, cell phone text sms message, affirmative voice response or login into the Shop OD internet website to confirm that the Shop OD purchase is permitted or authorized. This may all happen before the “generate ship order” step 136.

The Shop OD system may also include a privacy policy with multiple levels of opt-in or opt-out features. If a user selects all opt-in features, he or she may receive special discounts for goods-services and part of the unique user profiles downloaded into the STB with the Shop OD GD (metadata or configured VA). Higher privacy controls, selectable by the user, may be employed by the Shop OD system.

An inventory control sub-system may be employed at this juncture to “cease” offering the goods/services to the viewer/subscriber/user. This inventory control system is based upon uploaded data sent to the cable HE, and stored and ultimately delivered to the user's STB when the user downloads or re-sets his or her STB (part of the initial navigational GD download). A data status bit unique to one or more goods may be downloaded for effectuate the “goods will soon be sold out” or “none available” goods markers. For example, the goods/services display on the user's TV may be grayed out or labeled “SOLD OUT” to indicate this inventory condition. Alternatively, instead of an item being grayed out when sold out, a different on-demand VA could be shown, which notifies the user that the requested item is no longer available or suggests available alternatives.

The Shop OD 3^{rd} party server at the cable HE (Or Shop OD client app coupled to OD server) may be in continual communications with vendors of the goods and services such that the Shop OD applications server 24 has a relatively current count of goods/services available. This is just in time inventory control. This quantity limit code may be uploaded to the subscriber-user with the navigational GD. In a complementary manner, the Shop OD applications processor 24 may log-in all purchases of those particular goods and forward, on a continual basis, data to the vendors selling or manufacturing the goods. In this manner, a just in time inventory control system is provided by the Shop OD computer system. Supply data, representing the number of available goods for a region or locale, may be uploaded on the shop OD applications computer 24 periodically, or continually, dependent upon the viability of the communications channels to the vendors and suppliers. If video asset content must be changed, the menu metadata that points to the video asset may be changed to dynamically enable alternative video assets as desired. If, however, quantity status data, in the form of a small data packet, can be uploaded to the STBs via Shop OD client app on the cable HE, then the Shop OD program processed by the STBs can interpret this quantity status data, and gray out or text-mark the video asset as SOLD OUT. Other “sold out” displays or text messages may be used.

In step 142, the user receives a VOD buy confirmation message and the transaction ID is again delivered to the user. In step 144, the user acknowledges the “buy” order by return email, appropriate voice response or text sms OK reply (see supple-comm channels). In step 145, the Shop OD server system confirms the financial transaction. See steps 128-134 above. Typically, a credit card, debit card, or other electronic payment method is employed.

After some time, the shipper or vendor provides a “ship date” in step 146. In step 148, the Shop OD computer confirms the ship date with the shipper. In step 150, the Shop OD computer notifies the user of the ship date via the pre-selected communications channel. See step 140 above. The Shop OD client app may send metadata or configured VA to the user with this purchase history delivery notice. In step 152, the Shop OD computer server system handles user comments, complaints, approvals etc. This may occur via a telephone contact center, web site I/O, or cell phone text SMS.

FIG. 3c is a continuation of path B which is “not a member” path from step 104. In step 121, the set top box ID, the user data, a “new customer” notice, a goods ID and a discount marker is sent as a data packet from the cable head end to the Shop OD computer system. The “new customer” notice may be a data marker based upon the GD Guide Directory taken by the user (MEMBER or NOT MEMBER) is step 104. In step 123, a note is made of the following steps which occur at the Shop OD computer system. In step 125, the set top box ID is matched to correlate via a look up table or the database or spreadsheet application to identify the user name, address, phone number etc. from previously supplied data from the cable company. Of course, the cable company maintains subscriber contact data associated with a particular set top box ID since many cable subscribers also order a video on demand movies and other video content. When the subscribers order video on demand video asset, such as pay-per-view video assets, the cable system bills that subscriber for that ppv video asset. Therefore, any user contact data supplied to the Shop OD computer system and the set top box ID would be linked to the user contact data from the cable system operator is correlated in step 125. In step 127, the Shop OD system locates the current phone number of the customer, user or subscriber. In step 129, the Shop OD calls the user because the user has not previously logged into the Shop OD computer system and completed their profile. In step 131, the user provides contact data to the Shop OD computer system and this data is input. Alternatively, the user may use alternative data input path 131a. The user may call the external Shop OD system. In step 133a, the user goes on line to the website shopod.com. In step 135a, the user inputs his or her contact data, financial data and preferred communications channel data, etc.

In step 135, the user selects the preference communications channel, his or her email, mobile phone or cell phone, land line and text message sms communications path. This is the preferred comm channel and message format. In step 137, the Shop OD system matches the transaction ID generated by the cable head end with the user data and the discount code. Discount codes are used to incentivize the non-member to sign-up and become a Shop OD registered member. In step 139, the Shop OD computer system sets the table stored in the cable head end (the Shop OD client app) for a particular subscriber “OK to buy” which indicates that the particular subscriber is included in the Shop OD computer subscriber profile. In a preferred embodiment, the upload of data into the cable head end occurs rapidly via a high-speed network connection. However, a delay may be required in order to update the memory of the cable head end to indicate that a particular subscriber has an “OK to buy” status bid acceptable at the cable head end. In step 141, the cable head end sends the OK to buy status to the subscriber member set top box (metadata or configured VA). In step 143, the system goes back to jump point A-101, path A which is immediately after step 124 in FIG. 3b.

FIG. 3d shows general process flow chart showing one methodology of the Shop OD goods or services purchased by a registered subscriber-user. The process in this figure is fairly presented therein.

### Shop On Demand Navigational Guide, Shopping Tool, Purchase Selector and Transaction Process

FIG. 2 shows a VRN directory guide or Guide Directory, enabling a user to access a VOD asset catalog to Shop On Demand (“Shop OD”) via a navigational guide, shopper guide tool, selection process and transaction system wherein the GD is downloaded into the set top box STB at the initial set-up or when the user selects the text—“selectable button”—SHOP OD on his or her TV or display monitor. At each displayed GD level, the STB tunes to the streamed video assets (VA) for all the listed guide hot buttons, utilizing an asset catalog or asset preview and simplify the user selection. These guide hot buttons are displayed in a video rich navigational format or template, with frames (showing text which is electronically stored as a text file) and windows (showing video assets or VAs, linked to VA files), each of the text frame hot buttons and the window VA hot buttons being displayed “hot” or user actuatable portions of the display screen. These buttons are “hot” since the user can select a single button for further interaction with the STB and, ultimately, with the cable head end (HE). The user scrolls down the screen using remote 18 (FIG. 1) and then “selects” the hot button by depression of the “select” or “enter” key on the remote. The navigational button to be activated is highlighted on the TV screen or monitor.

FIG. 2 shows a hierarchical Guide Directory “GD” enabling user selection, such as the first level GD-L1 listing “channel directory” (this text file is a frame which displays textual information to the user/viewer and this hot button or navigational button further electronically points to a VA-c or the initial video asset for the channel directory “c”), “Shop OD” (the GD navigational text points to a VA-s or video asset for Shop OD file “s”), and “VOD” or video on demand directory listing (the text file displays a navigational button to the user and electronically points to VA-v or VA-video on demand asset “v”), and others. If the user selects SHOP OD, the GD shows text navigational hot buttons “NOT A MEMBER” or “MEMBER” in the frame of the display. These displayed hot buttons are text files stored in connection with the Guide Directory under the Shop OD sub-directory. If the user is not a pre-registered member of the Shop OD system (discussed later herein) and the user selects “not a member”, the GD tree may be the same except for the last permissive “hot button” set or “BUY ON” button (explained later).

In the event a user selects “Member” when, in fact, that user is not a pre-registered Member of the Shop OD system; a spurious “buy” for goods may be registered. However, this spurious “buy” order will not be processed by the Shop OD system because the STB id sent with the buy order from the “not a member” user will not match the list of STB ids in the Shop OD master computer system (or Shop OD client app on cable HE) and further the spurious buy order will cause the Shop OD computer system to respond to the “not a member” viewer. The non-member would be provided with an option to enroll as a “member” and facilitate a “buy” order via an off-line telephone number. The non-member would simply provide a transaction ID and complete their purchase following a successful telephone “member” enrollment.

As for the “member” GD branch, the next GD level down is STORE, BRAND, CATEGORY and sub-directories below this GD-L3 directory level are APPLE, BODY WORKS, SEARS (below “STORE” GD); APPLE, IZOD and RALPH LAUREN (below BRAND GD); and CLOTHES and TVs (below “CATEGORY” GD). Below the “TV” Guide Directory level is Hi Definition, Projection and LCD listings. These are text, user actuatable buttons displayed on the user's TV or monitor. Below the LCD GD level is size, price brand, beneath size is 10″, 12″ and 14″ and beneath 10″ GD level is a listing of all 10″ LCD TVs, each listing pointing to a VA for that particular TV. The VA displayed to the user is shown in windows of the display screen. These windows may be navigational buttons (hot buttons) or may be passive, non-navigational elements. The same theory of operation is employed in website designs with hot, navigational display areas and passive display areas, all on the same website. Although the theory of operation is the same, the implementation in a VOD setting, with very little view space and limited functional aspects for the STB, is difficult to design and implement.

Additionally, the Shop OD system includes an exit console with a text navigational frame button “BUY NOW”. Additional features include offers to permit the user to add preferential buying data to his or her personal STB profile, in the Shop OD sub-system at the cable HE, or otherwise (e.g., through website, phone, call center, IVR, etc.). The user may want user preferences and user selectable promotional VAs and text frame data, unique to his or her personal identification number PIN or unique to the STB. These aspects are discussed in more detail below.

Transaction Process Controller with User History, Selectable Purchase, Confirmation and User Control Options for Shopping with Video on Demand Cable Systems The Transaction Process Controller, Confirmation, and Control Options in General

The shop on-demand purchasing program enables a user-viewer to participate in a purchasing program via the user's interactive television set, typically an STB enabled television. The interactive television set, as known to persons of ordinary skill in the art, is coupled to a cable system network and a cable head end with streams VAs sent to the user upon request or command. Such VAs include pay-per-view PPV movies and entertainment events. As is known to persons of ordinary skill in the art, the interactive television set or STB has a unique set identification ID code which differentiates the STB in the cable system network from other interactive television sets. The user can view goods or services upon command via the interactive television set since the shop on-demand VAs are streamed to the interactive television set as necessary. In response to a buy-now command from the user for specific goods/services, the present purchasing method generates a transaction ID code with an algorithm correlated to the set ID code. The transaction code corresponds to the specific goods or services ordered by the user. The transaction ID code is displayed to the user on the interactive television set and also is transmitted via the cable network to the shop on-demand computer server via the cable head end or to a shop on-demand client application operative at the cable head end. Client applications located at the cable head end server interact with the cable HE server. The shop on-demand client application is one of those applications in one embodiment of the invention. Preferably, the transaction ID code is generated via the interactive television set or STB prior to transmission to the shop on-demand computer server or client application. At the shop on-demand computer server, communicatively linked to the cable HE or shop OD client application, a specific goods/services order is created and a financial transaction request is initiated which causes the user to be debited for the goods or services ordered. An order is sent to a vendor or vendor fulfillment center-provider. Both the goods order and the financial transaction request is keyed or linked to the transaction ID code.

The algorithm which creates the transaction code does so by correlating the set ID code with one of the following: a specific goods or services ordered by the user, a chronologic event (which is one or more of a date, a time, and a date and time code) and a random number or character set. In this manner, the transaction ID is always unique to the purchase by the user and the set ID code. The set ID code is physically linked to the user. Further, the shop on-demand server can then decode the transaction ID, with a decoding algorithm, in order to ascertain whether a valid order was obtained from the set ID code and the correlated data. This is important in a transaction dispute. The transaction ID is also preferably sent via a supplemental communications network to the user. The supple comm channel is cell phone message (voice, SMS, text etc.) or a voice over Internet protocol (VoIP), a terrestrial land line telephone network, or a global computer communications network, commonly called the Internet. These channels, which may be preferential, inform the user of the transaction ID. Of course, the shop on-demand computer server saves the transaction ID and the date of the order and the goods or services ordered. In a further enhancement, the purchasing system generates a purchase record composite signal which is a composite of the transaction ID and an indicator of the specific goods or services purchased by the user. This composite signal may be the transaction ID plus an image of the goods or services, or a signal representative of the image or a textual description of the goods or services. The purchase composite signal is preferably generated by the shop on-demand computer server or the shop on-demand client application operative at the cable head end. The composite signal is transmitted to the interactive television set as a “composite signal” or record formative signal from the group of record formative signal including video on-demand (VOD) menu metadata, VOD asset metadata, VOD asset from the cable head end (a VA modified by shop OD system) and a VOD asset from the shop on-demand client application operative at the cable head end. Preferably, the indicator, in the purchase composite signal, causes a representative display of the specific goods or services purchased by the user upon a recall command initiated by the user via the interactive television set. The “effecting a display” means that the cable HE or shop OD client application cause the user's STB-enabled TV to show the noted display. The purchasing system also forms a purchase order history with a plurality of purchase record composite signals associated with the set ID code at the shop on-demand computer server. The purchase order history is a list of all goods/services ordered/bought/delivered to the user. Since this data is available at the server, the data is also made available at the cable head end and the shop on-demand client application operative at the cable HE. The purchase order history is transmitted to the user's interactive television set via the cable head end as a record formative signal discussed above. The user calls up, upon command, the purchase order history.

The purchasing method, in addition to storing the purchasing order history, also gathers user-viewer profile data via an enrollment communications channel from the supplemental communications channel discussed above. The shop on-demand computer server enables the user to set purchasing limits in the form of one or more or a combination of time of day, day of week, monetary limits, user-buying code IDs (PINs or multiple family member PINs) linked to the user's interactive television set and set ID code. The shop on-demand computer server limits purchases within these purchasing limits. For example, the user may want to block all shop OD purchases between 8 AM and 8 PM to exclude the possibility that the user's children will purchase things during that time frame. Monetary limits may be set as discussed above. By posting this information at the shop OD computer server, the user can visit the shop OD computer server, (with the proper password control) and change or alter these user purchasing profile limits. This access is provided via the supplemental comm channels. Voice, IVR, telecom call centers, and voice mail systems may be employed by the shop OD server. Further, the shop OD computer server employs financial fraud and abuse routines correlated to the purchasing limits and purchase order history. In other words, if a person has been buying shop OD goods on the order of $100.00-$200.00 per month and then suddenly places an order for $5,000.00 goods/services, the shop OD server may block the order process until acknowledgment from the user is obtained. Acknowledgment voice print and/or IVR, may be employed. As such, a purchasing limit override communications channel to the user is employed using the supplemental communications channels discussed above. Preferential channels are employed.

The user is assigned a personal ID or PIN and multiple members of the user's household are also assigned personal IDs which have different associated purchasing limits and purchasing control elements discussed above. The shop OD computer system applies these purchase limits to purchases prior to affecting the generation of an order for specific goods or services and a financial transaction effective signal. Further, a parental control unit can be linked to the purchasing limits at the shop OD computer server. Representations of the parental control limit can be sent to the interactive television set as control formative signals discussed above such as VOD menu metadata, VOD asset metadata, VOD asset from the cable head end and VOD asset from the shop OD client application operative at the cable head end.

Alternatively, if the processing capabilities of the STB is limited, the transaction ID may be created at the cable head end HE. In such situation, the transaction ID code is sent to the interactive television set (STB enabled TV) for display to the user. Effectively, the transaction ID is compiled as an algorithm correlated to the set ID and the specific goods or services. The transaction ID code when created at the cable HE (or the shop OD client application), is sent to the interactive television set by a formative signal such as a VOD menu metadata, VOD asset metadata, VOD asset from the cable head end streamed to the STB or a VOD asset from the shop OD client application streamed to the STB. These VOD assets would be inserted into the streaming VOD sent down to the interactive television computer user.

### Details of the Transaction Process Controller, Confirmation, and Control Options

The user may set purchase control routines for a video Shop on demand cable system. The transaction process controller enables the user to enable or disable or set limits to select purchase control features or purchase permitted levels and a confirmation control option for shopping with video on demand cable systems. These purchase controls can be set at enrollment or re-set subsequently by the user or the Shop OD system administrator may pre-set these limits and controls and purchase authorizations. In summary, the user or subscriber is enabled, via the Shop OD system, to set the “buy ok” status data high, indicating that all purchases are permitted via the Shop OD system, or to set the “buy ok” status low, blocking all purchases. If the “buy ok” status is low, then all purchases via the Shop OD system must be pre-approved via an alternative communications channel (voice, cell, text SMS, Internet or email) confirmation routine. Additionally, the user set purchase control may be set to approve purchases at certain levels, for example, user automatically approves all $20.00 or less purchases without further confirmation via alternative communications channels, or pre-approves all $50.00 or less purchases or pre-approves all $100.00 or less purchases, without specific authorization-confirmation for such purchase. Each good offered via the Shop OD system has a level indicator, that is, less than 20, or less than 50 or less than 100 so that controls may be employed to limit the potential of fraudulent purchasing activities. Personal identification codes or PINs may be added to the purchase control system and these PINs may be employed in conjunction with certain purchase limits.

The Shop OD system can be configured to determine or control who is using the system and which STB the user is interacting with based upon the follow proposed levels of preset approval and/or security code PIN controls:

| | |
|---|---|
| Household - | level one |
| Set top box - | level two |
| Authorized users - | level three |
| PINs - | level four |
| Definition of PINs (e.g., limits, | level five |
| additional confirmations) - | |

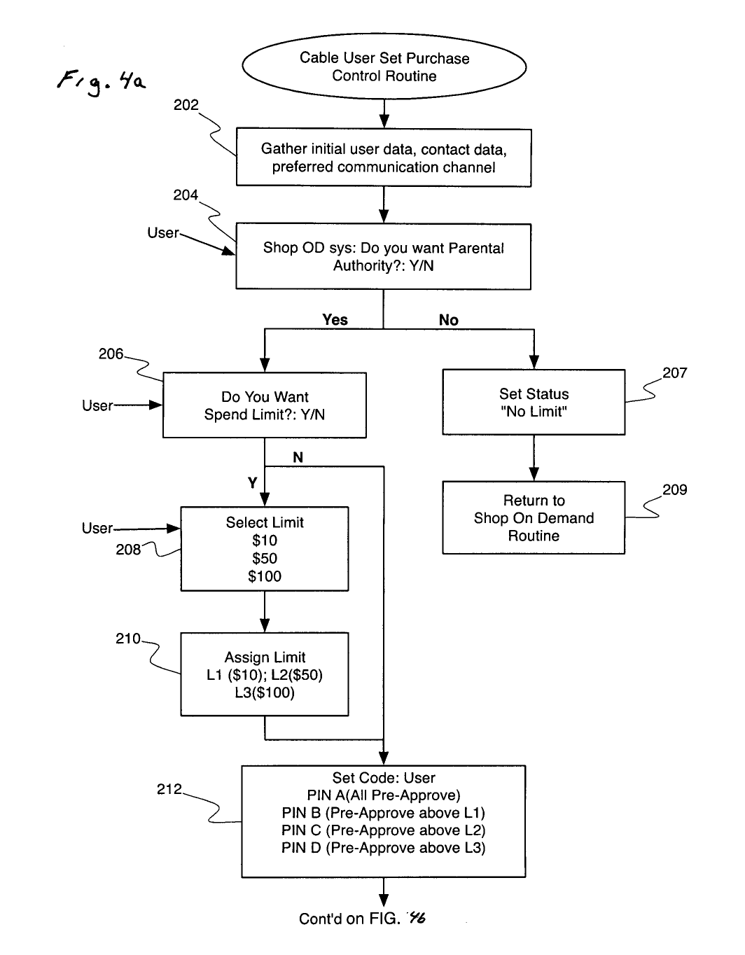

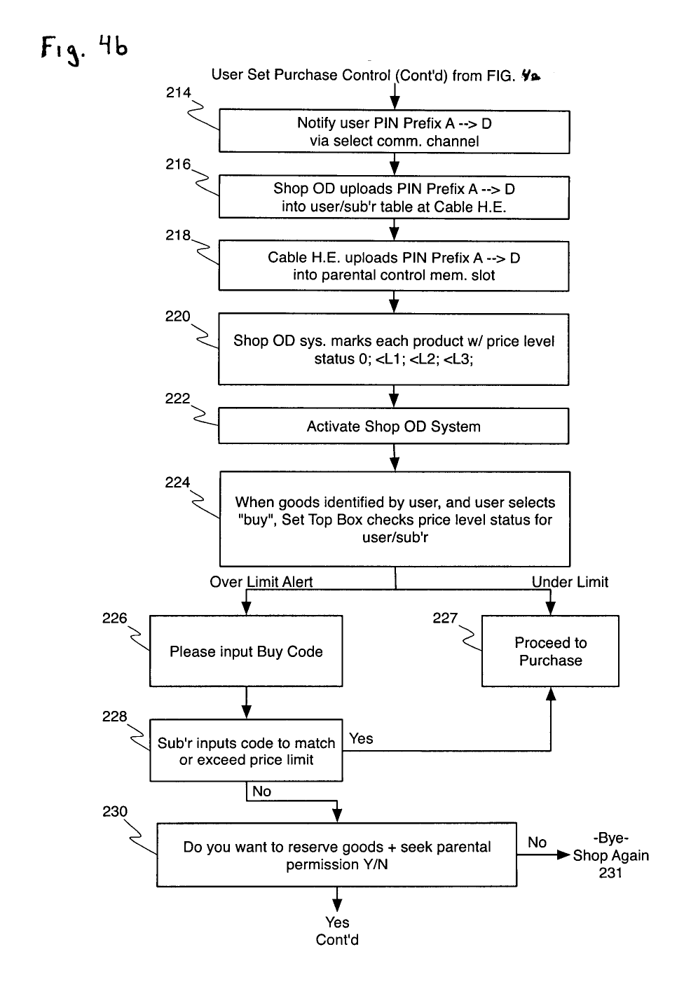

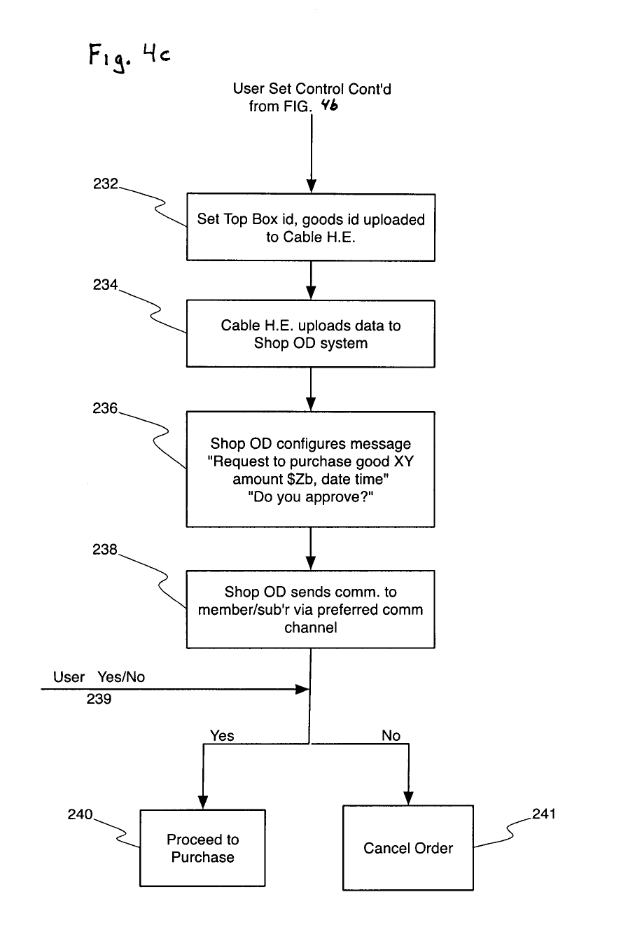

FIG. 4a shows a user set purchase control routine for a Shop on demand (Shop OD) VOD enabled cable system. Step 202 gathers initial user data, contact data and preferred communications channel data from the user. In step 204, the Shop OD computer system asks the user/subscriber if he or she wants to assert parental control (or purchase control) on the particular set top box approved by the user. This occurs either during initial set-up by the new user (or is resettable by the user later) and the Shop OD computer or during a “change user profile” routine. The user purchase control status bit or data may be linked to the Member status data located in the Shop OD Guide Directory discussed above. If the subscriber selects the NO branch during the user profile input routine on the Shop OD computer system, the system in step 207 sets the status bit or data package “No limit” entry in the user profile which permits all purchases of on demand shopping via the VOD system. In step 209, the system returns to the Shop on demand routine. FIG. 3a. If the YES branch is taken after 204, the user in step 206 determines whether he or she wants to put a limit on the purchases. If the YES branch is taken, in step 208, the user selects limits such as $10, $50 or $100. Other purchase limits may be available. In step 210, the limit is assigned to the user profile as L1, L2 and L3 representing the monetary limits displayed and selected by the user in step 208. If the NO branch is taken from step 206, the system in step 212 sets and displays for the new user either “NO PIN” or pin A, B, C or D which indicates that all Shop on demand purchase are OK, each purchase must be approved (pin A), or only purchases above level 1 need pin approval (B), or above monetary level 2 (C), or pre-approval is needed for any purchase above monetary level 3 (PIN D) which, as an example, is $100.

To enhance the confirmation BUY process, the Shop OD system may include a certified authorization routine which records the user's approval to BUY the goods, by voice recording, voice print, and/or electronic confirm receipt BUY communications (“DO YOU AGREE TO THE TERMS”, user responds electronically YES—typically IVR routine).

The system then jumps to FIG. 4b and step 214 which notifies the user of the PIN prefix A, B, C or D via the selected communications channel. In step 216, the Shop OD system uploads the pin prefix A-D into the user subscriber table at the cable head end. This may be an alteration of the GD for the Shop OD GD for the particular subscriber at the cable head end. Other data store and forward systems may be utilized. In step 218, the cable head end accepts the pin prefix A-D into the parental or purchase control memory slot in the Shop OD client app or Shop OD server at the HE. An upload to the STB may occur when the “Shop OD” menu is called by the user, step 102, A1, A2 (metadata or configured VA from Shop OD client app/server). The theory of operation is that the set top box can be dynamically “programmed” by the user to block certain violent content channels with metadata and/or mature content channels displayed to a viewer on the television set associated with set top box. Therefore, when a young child seeks to view mature content, the child must input a pin (personal identification number or code) into the remote control in order to open or play the VA on the STB—set top box. Without a conforming PIN-metadata, Shop OD processes are blocked. In a similar situation, the Shop OD system can utilize that pin system in order to prevent unauthorized purchases or purchases over a predetermined amount via VOD shopping. Therefore, this is a user set purchase control routine.

Features of the purchase control include:

set household buy limits (system administrator)

assign master user id
assign master pin OK to buy
assign servant 1, 2, 3 pins OK to buy at levels 1, 2, 3
assign confirmation levels (OK TO BUY) for master and servants 1, 2, 3—may require different levels of confirmation approvals (cell phone text message, vs. oral approval vs. email or website confirm process) and different communications channels and record approval code authorizations.

Of course, the user/subscriber may disable all purchase controls and pins and pre-approve all purchases. This “approve all purchases” may trigger an IVR routine and a recorded conversation with the user and storage of the approving voice print at the initial sign-on phase. If the user disputes the Shop OD purchase control in the future, this voice print APPROVAL conclusively establishes the user's authorization level.

In step 220, the Shop OD computer system marks each product guide data point or package with a price level status L1, L2, L3 such that when the goods ID and price point level (less than $10, less than $50, or less than $100 or more than $100) is matched to the user profile at the STB, the Shop OD-VOD system, at the STB, can quickly determine whether the “intended purchase” product exceeds one of the levels L1, L2 or L3 (This purchase approval may be processed at the cable HE at Shop OD server 24). Alternatively, the Shop OD process may lock-up goods/services price table at the Shop OD client app/server. In step 222 the Shop OD computer system is activated. In step 224, goods are identified by the user via Shop OD routine (FIG. 3a) and the user selects the BUY NOW button. The set top box checks the price level status of the goods with the purchase level status of the user subscriber. If the set top box/Shop OD process determines that the level status for the user subscriber and the goods is under the limit, the set top box proceeds to purchase in step 227. PIN input may be additionally required of the user/viewer.

If the subscriber does not want any limits on the purchase of goods/services over the Shop OD system, this sub-routine may not be employed. Alternatively, if the vendor of the goods/services is not particularly concerned with returns and refunds, no prior BUY NOW limit routine or BUY CONFIRMATION limit—trigger routine may be employed. This is especially true of the delivery of digital goods when the cost of manufacture and delivery is low and the acceptance rate of the goods is high and the cost to refund erroneous or returned goods is not too burdensome.

Additionally, the Shop OD administrator (which may be automatically implemented by an automated routine) may increase the spending limits for one or more subscribers based upon (a) spending patterns of a particular member, (b) seasonal buying patterns (for example, heavy holiday buying periods, e.g., end of year gift giving); and (c) other factors typically employed by vendors and suppliers of credit in the merchandising chain. In addition, the Shop OD system may include fraud and abuse sub-routines which either de-select a pre-registered member (in the event of fraud or abuse detection) or in the event of excessive volume of returns and refunds. The Shop OD administrators may employ other credit-purchase management systems or automated systems to facilitate these fraud and abuse programs. Further, upon detection of fraud, abuse or improper buy/return practices, the Shop OD system may, at the administrator-operator level, impose additional subscriber confirmation programs to curb these practices.

If an over limit determination is made by the set top box comparing the pin prefix A-D to the level indicator L1, L2, L3 associated with the video asset of the product displayed on the set top box and subject to the “buy now” selection of the user in 224, the system in step 226 requests that the user input the “buy pin” code. The buy code is a pin that will match pin prefix A-D. In step 228, the subscriber inputs a code to match or exceed the price limit L1, L2, L3 set for the particular goods. If YES, the prefix pin code input matches or exceeds the product level L1-L3, the system goes to “proceed to purchase” step 227. A pin prefix is used because each user may add his or her addition al code to the pin to control VOD purchases. If the NO branch is taken, the system in step 230 requests if the user wants to reserve the goods, tells the buyer that he or she is not authorized to purchase the goods at this time and requests that the buyer seek parental or further “buy” permission. If not, and the user does not want to reserve the goods for review by an authorized buyer at a later time, the system takes the NO branch and goes and displays “Shop again” in step 231.

In step 232, in FIG. 4c, the system in the set top box identifies the STB ID, identifies the goods identification and uploads this information to the cable head end or Shop OD client app. In step 234, the cable head end uploads this data to the Shop OD computer server system. In step 236, the Shop OD computer system configures a message with “request to purchase goods XY, amount XXX, date and time” and asks via the preferred communications channel whether the user wants to approve. In step 238, the Shop OD computer system sends via the preferred communications to the subscriber/member via the preferred communications channel. In step 239, the user selects YES or NO via the preferred communications channel. If NO, the system in step 241 cancels the order. If YES, the system in step 240 proceeds to purchase. The Shop OD system may optionally not contact the member user in step 236, 238, 239, 241.

Additionally, the Shop OD system may include, for certain level users (see table above) that the user answer or respond to certain multiple choice questions. Essentially, the system requires that the user/viewer answer pre-defined questions in order to confirm that the user is permitted or authorized to make the proposed purchase. The use of challenge questions is common in other financial transactions to verify the user's identity.

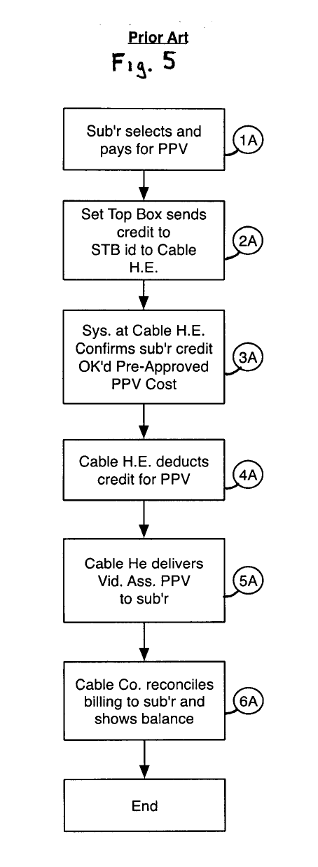

In FIG. 5, a prior art system is disclosed. In step 1A, the subscriber selects and pays for pay-per-view. In step 2A, the set top box sends a credit to the set top box cable head end. At step 3A, the system at the cable head end confirms that the subscriber is pre-approved (has appropriate credit available) for the selected ppv content. In step 4A, the cable head end enables subscriber access to the ppv content. In step 5A, the cable head end delivers the video asset ppv to the subscriber. In step 6A, the cable company deducts the credit associated with the chosen ppv content. When a user is out of credits, they have hit their spending limit and must purchase additional credits in order to access additional ppv content.

### Alternative Offline Parental Control and Preferred Content Delivery and Preferred User Communications Path for Video on Demand Cable System

In summary, this alternative control system permits the user to set various preferences for (a) access to buy; (c) credit card charge limits; (c) goods and digital content delivery channels and (d) preferred communications pathways back to the user. The preferences are set by the Shop On Demand user when the user enrolls. When website or online enrollment is permitted, the user selects the level of “buy authorization” (ok to buy $20 or ok to buy up to $50, etc.) and the user selects how the Shop OD system should communicate with the user, via cell phone voice, cell phone text SMS, land line voice, email, etc. Delivery systems such as all music goes to iPods xxx, or all video movies go to set top box # or all goods go to address xxx.

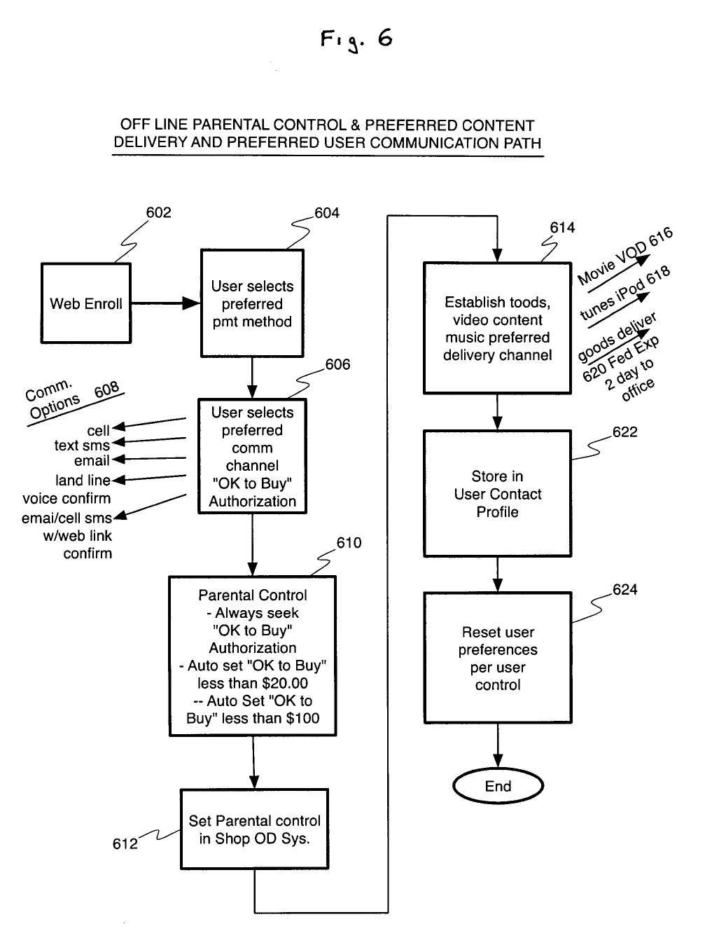

FIG. 6 shows an offline parental control and preferred delivery and preferred user communications path system for a video on demand cable system. In step 602, the user or subscriber for the Shop on demand system enrolls to the Shop on demand or Shop OD computer system by way of the Internet. Limit VOD enrollment is discussed above in the Enrollment Section. In step 604, the user selects a preferred method of payment for the Shop on demand goods which he or she may purchase in the future. In step 606, the user selects one or more preferred communications channels in order to receive confirmation, confirm or authenticate the purchase of goods. In one sense, this may be “OK to buy” authorization communications channel. The communications options are shown in 608 as a cell phone voice message, a cell phone text sms message, an email message, a landline voice confirm message or an email/cell phone text message sms with a web link confirm communications path. The user may select or prioritize one or more of these in the current system. A comm channel and message format preference is set by the user. In step 610, the user selects the parental control. The user can select that any purchase via the Shop on demand system is “OK to buy” Alternatively, the user may select levels such that it is “OK to buy” items less than $20, or OK to buy items less than $100. In step 612, the parental or purchase level control is set in the user's contact or profile information and the Shop OD computer system.

In step 614, the user in his or her profile establishes how particular goods, video content and music should be delivered. For example, the user may select that all video on demand movies and video content be delivered to the TV at step 616. On the other hand, audio music in the form of iPod tunes may be delivered to a particular iPod or website in step 618. In step 620, all goods should be delivered to a particular location associated with that customer.

In step 622, the information is stored in the user contact profile with the Shop OD computer system. In step 624, the user is permitted to reset his or her preferences on the user control.

### Inventory Control with Content Cache, Time Scarcity Marker and Merchandising Incentives for Transactional Shopping Video on Demand Cable Systems

The Inventory Control, Time Scarcity Marker and Merchandising Process in General

The inventory tracking and purchasing method includes, in one embodiment, a time scarcity marker and, in another embodiment, merchandising incentive for the transactional shopping on-demand or OD purchasing program. With respect to the inventory tracking and purchasing method, goods or services are advertised to the user-viewer via the interactive television set (preferably, the STB enabled TV). An inventory sales indicator is transmitted from the cable head end as an inventory formative signal from the group of formative signals including VOD menu metadata, VOD asset metadata, VOD asset from the cable head end and a VOD asset from the shop OD client application which is operative at the cable head end. The inventory indicator originates from the shop OD server, which may be linked to the vendor's computer. This provides a just in time inventory control. The shop OD process effects the display of inventory scarcity indicia to the user in conjunction with the advertising of specific goods or specific services. The inventory scarcity indicia is associated with a plurality of tracked goods or services. These tracked goods or services are associated with the corresponding inventory sales indicator in the shop OD computer server. Periodically, or as necessary, the shop OD computer server updates the corresponding inventory sales indicator for the associated tracked goods or services based upon vendor supplied data. In this manner, a just in time inventory control is provided for the shop OD purchasing system. In other words, the shop OD computer server tracks vendor supply data and inserts an inventory sales indicator as one of the metadata signal from the menu, the metadata signals from the VOD asset, or inserts this inventory sales indicator into the VOD asset streamed from the cable head end via a VA pump to the user's STB or inserts the inventory sales indicator into a VOD asset which is supplied by the shop OD client application which is operative on the cable head end. The updated inventory sales indicator from the shop OD computer server is applied to either the cable head end or the shop OD client application as a precursor to the inventory formative signal. In other words, the inventory sales indicator may change from the shop OD computer server to the cable head end which might only supply a representative signal to the user's STB and interactive television set. In any event, the user is supplied with an actual inventory count (just in time controls) or a ficticious inventory indicator which spurs users purchases.

The inventory sales indicator may be an actual indicator of inventory available by the vendor submitting his or her goods or services through the shop OD purchasing system or maybe a ficticious inventory level. It is known that increased sales occur when the prospective buyer views a limited time offering or a limited quantity or inventory of goods or services for sale. Therefore, an actual or ficticious inventory level associated with tracked goods or services is provided and this actual or ficticious inventory level may include a low inventory level indicator, a sold out inventory level indicator, inventory levels that are available for a predetermined period of time or inventory levels that are available only at a discounted price. Spurious inventory signals may be a merchandising incentive to purchase.

Another method of incentivising or increasing sales is to provide a time count down for the goods or services offered for sale of goods or services. In the shop OD purchasing system of the present invention, the time countdown is either provided by the clock on the interactive TV (preferably the STB) or as a VOD menu metadata, VOD asset metadata, VOD asset from the cable head end for the VOD asset from the shop OD client application. The VOD metadata or VOD asset supplies countdown markers or displays. Particularly with respect to VOD asset, the time countdown may be only a simulated time countdown since VOD assets are not absolutely tied to an actual clock. In other words, the VOD asset or VA may show time increments which are different than actual time increments.

In addition to the foregoing, a discount coupon may be provided with certain tracked goods or services. The discount coupon could be a discount formative signal based upon the VOD menu metadata, VOD asset metadata or VOD asset from the cable head end or the VOD asset from the shop OD client application. If the discount coupon is not tied to the inventory scarcity signal or the time countdown signal, the discount formative signal must be provided as part of the VOD menu metadata or VOD asset metadata.

### Details of the Inventory Control, Time Scarcity Markers and Merchandising Process

The inventory control employs a content cache merchandising system which, in summary, employs a “fresh timestamp” applied to each video asset as that asset is streamed to the user-subscriber's set top box STB via the cable head end HE. Alternatively, the fresh time stamp may be added to the Guide Directory as metadata the GD is uploaded to the user's STB in order to permit a “time out” function during a transactional shopping experience. Each GD or video asset has (i) content and (ii) a “permissible time frame play period.” The cable head end stamps the GD or video asset with a day/time. The set top box checks the fresh time stamp and the permissible play time, and if the stamp falls within the play period, the box plays the asset or permits the user to navigate further down the Shop OD GD menu tree. If not, the box does not play the asset/GD sub-menu.

The prior art employs an AOI as controls for subscriber-view-limit and licensing-window-end.

Additional features include tracking inventory via a Shop OD server at the cable HE, advising the user/member that inventory of particular goods are low or the quantities are limited, just in time inventory data signals generated by the Shop OD system to vendors, time clock features to notify members/viewers that sales of certain goods are limited and the quantities of such goods are reduced on a time clock based manner.

An inventory control sub-system may be employed at this juncture to “cease” offering the goods/services to the viewer/subscriber/user. This inventory control system is based upon uploaded data sent to the cable HE from the Shop OD server, and stored and ultimately delivered to the user's STB when the user downloads or re-sets his or her STB (part of the initial navigational GD download (metadata or configured VA)). A data status bit unique to one or more goods may be downloaded for effectuate the “goods will soon be sold out” or “none available” goods markers. A special VA may be also used. For example, the goods/services display on the user's TV may be grayed out or labeled “SOLD OUT” to indicate this inventory condition. Alternatively, instead of an item being grayed out when sold out, a different on-demand VA could be shown, which notifies the user that the requested item is no longer available or suggests available alternatives.

The Shop OD 3^{rd} party server at the cable HE may be in continual communications with vendors of the goods and services such that the Shop OD applications server at the cable HE has a relatively current count of goods/services available. This quantity limit code may be uploaded to the subscriber-user with the navigational GD (metadata or special VA). In a complementary manner, the Shop OD applications processor may log-in all purchases of those particular goods and forward, on a continual basis, data to the vendors selling or manufacturing the goods. In this manner, a just in time inventory control system is provided by the Shop OD computer system. Supply data, representing the number of available goods for a region or locale, may be uploaded on the shop OD applications computer periodically, or continually, dependent upon the viability of the communications channels to the vendors and suppliers. If video asset content must be changed, the menu metadata that points to the video asset may be changed to dynamically enable alternative video assets as desired. If, however, quantity status data, in the form of a small data packet, can be uploaded to the STBs attached to the cable HE, then the Shop OD program in the STBs can interpret this quantity status data, and gray out or text-mark the video asset as SOLD OUT.

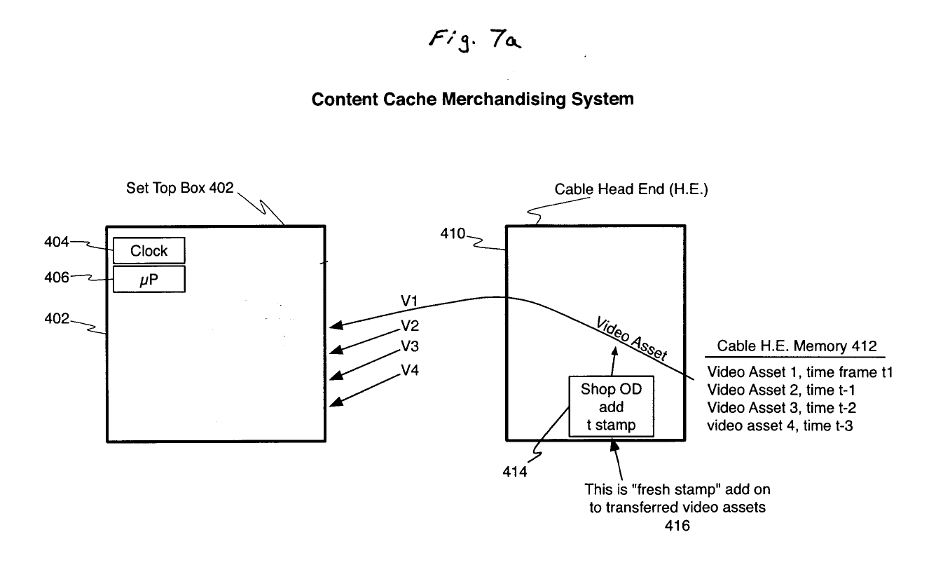

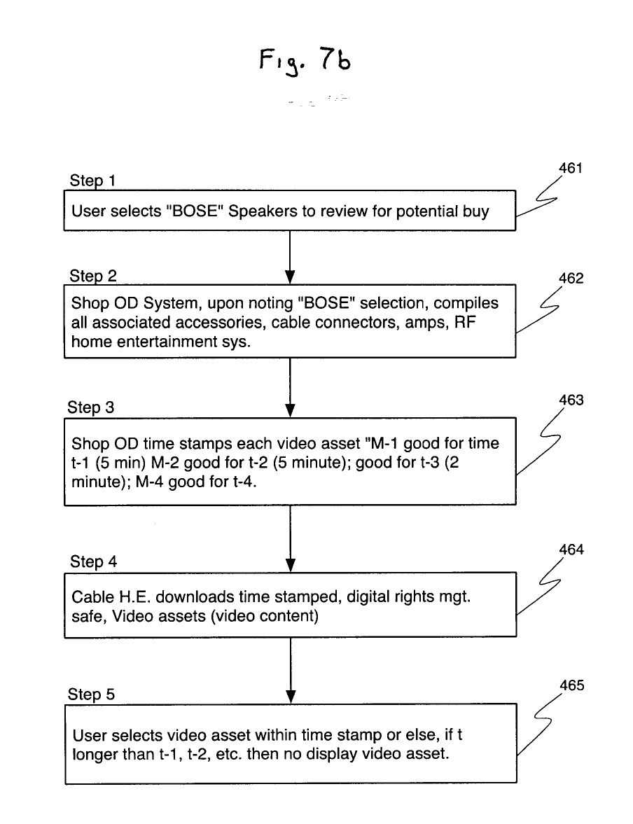

FIG. 7a shows a content cache merchandising system for video on demand cable systems. The set top box 402 includes a clock 404 and a micro processor 406. The cable head end 410 includes a cable head end HE memory 412. The HE memory 412 includes a means of storing video assets such as video asset 1, 2, 3 and 4, placed into memory or on disk. Alternatively, the VA 1, 2, 3, 4 may be GD levels or branches in the Shop OD GD menu guide. Each video asset or GD-L has a preset “play time” time frame. For example, video asset 1 or GD-L may have a preset play time frame of twenty four hours. Video asset 2 or GD-L may have a preset time frame play time of two hours. Video asset 3 or GD-L may have a preset time frame of two hours. Video asset 4 or GD-L may have a preset time frame of one hour.

In step 414, when the user at set top box 402 selects a particular video asset or GD-L, the cable head end at function 414 stream downloads the GD-L called by the user and inserts a Shop OD time stamp into the GD-L. This is a “fresh stamp” data packet. This may be metadata. This time stamp uses the day and time the video asset or GD-L is delivered to the subscriber. When the fresh stamp day and time stamp is added to video asset 1 or GD-L, the user is permitted to see video asset 1 or GD-L for a period of twenty-four hours from the fresh stamp time. The preset time play frame T1 for video asset 1 or GD-L is keyed to the fresh date and time stamp in function 414. The STB has a process that confirms VOD play within that time frame.

The particular operation is shown in FIG. 7b steps 1-5. In step 1, 461, the user selects Bose speakers to review for a potential buy (GD-L or VA). In step 2, 462, the Shop OD system, upon noting the Bose selection by the user, compiles all associated accessories associated with the Bose or any other high-end speakers. These complementary goods or accessories may be cable connectors, amps, radio frequency home entertainment systems and such like that. Alternatively, the Shop OD GD may be forwarded and streamed to the STB as special VAs and this GD VA may carry fresh time stamps therein. In step 3, 463, the Shop OD time stamps each GD-L (process 414) such that video asset M1 or GD-L is good for play time T-1 which may be five minutes from the download time. Video asset 2 or GD-L is good for time T-2 which is five minutes. Video asset M3 or GD-L is good for T-3 which is two minutes and video asset 4 or GD-L is good for time frame T-4. In step 4, 464, the cable head end downloads the time stamped digital rights management safe video asset. If deployed in the GD, the system may be properly called a digital rights management system. In step 5, 465, the user selects the video asset or GD-L and the set top box 402 checks the time stamp on the video asset or GD-L. If the time stamp is greater than the current time in clock 404, the video asset or GD-L plays. If the time stamp is less than the clock 404, the video asset or GD-L does not play. In this manner, the memory of the set top box can be loaded with significant video content or GD-L showing Shop on demand content and, after a predetermined time period, this memory can be cleared out to store other video on demand assets or GD-L.

To achieve a “perceived scarcity” marketing plan, the goods VA with the time stamp may “clock down” and have a text frame displayed showing that the quantity of goods is being sold “in live time.” After the time clock on the STB processor time outs (the time period for the goods expires), the TV display would show the viewer-user “SOLD OUT” thereby giving the user the impression that there are no longer goods of that nature available for sale.

Alternatively, the Shop OD third party applications server has continually downloaded small data packets to the user's STB showing limited quantities of goods offered for sale. This limited quantity data may be displayed to the user.

Once the time our period expires or the quantity is less than a set amount (maybe zero), a default screen is presented to the user as a filler for other VAs. When the good or service is no longer available (because the time expired or the item sold out), the Shop OD system may suggest alternative VAs or products that the user may want to purchase, or sign up for. Metadata tags may trigger a “sold out” screen or a clock count down series of VA screens. An alert can be sent to the user if/when the desired-but-unavailable-product becomes available again.

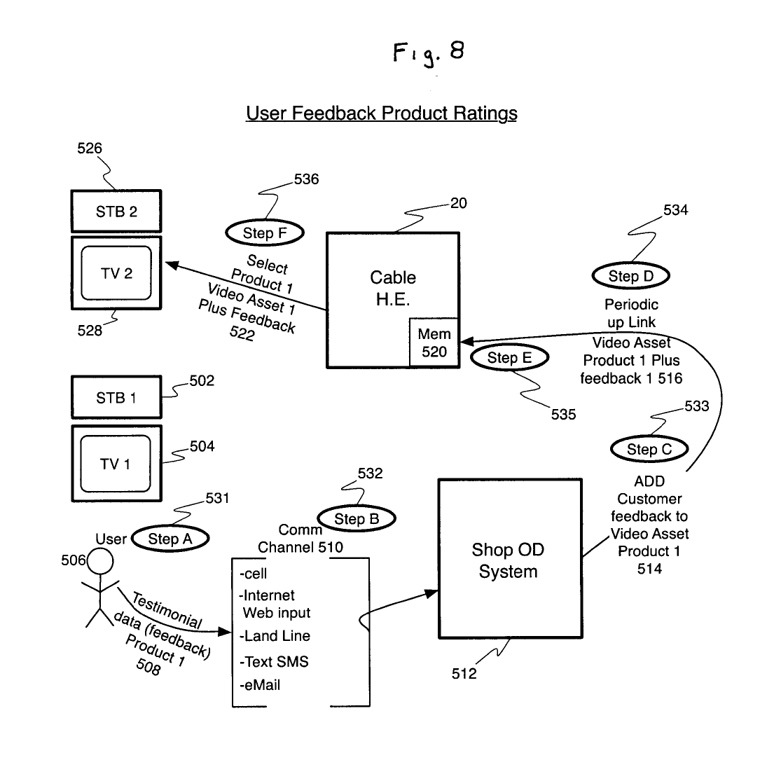

On the back-end, the Shop OD computer 24 can keep track of sales made and forwards goods sold data to the Shop OD master server computer (see FIG. 8, system 512) and, with a just in time inventory control, a “prospective” buy order for the goods/services purchased by the users connected to the cable HE. These prospective buy orders are replaced with confirmed buy orders which are normally sent by the Shop OD master computer system, after confirmation and payment authorization for the purchase. In other words, goods are not ordered until payment is confirmed.

### User Feedback Product Rating or Commentary for User Profile for VOD System

In summary, user's comments are gathered by the Shop OD computer system via an alternative communications channel (cell phone, Internet, email, voice land line) and the user's comments are added to the video asset which was the subject of the user's comments. This user feedback for the video asset is added to the vide asset and the Shop OD system uploads periodically the video assets to the cable head end. Hence, the video asset with the user's comments acts as feedback into the video Shop on demand system.

FIG. 8 shows a video feedback product rating system or goods comment system for video on demand cable system which can alternatively be utilized for a user-contribute how-to video, an offer for an related good or service, background information on various goods, repair instructions or other data of interest to the user. Set top box 1, as unit 502 is associated with TV1 as unit 504. User 506 interacts with set top box 502 and TV 504. In step A, 531, testimonial data from the user is delivered via a preferred communications channel 510 (step B, 532). The testimonial data packet 508 can be sent as text, audio, video, or images via cell phone, internet web input, land line, sms short message service, text message via cell phone or email to the Shop OD computer system 512. In step C, 533, the Shop OD computer system adds the customer feedback data to the video asset for product 1. See step 514. In step D, 534, the Shop OD computer system periodically uplinks the video asset plus the feedback to cable HE. See step 516. In step E, 535, at the cable head end 518 and particularly memory 520, video asset 1 plus the customer feedback 1 is stored in the HE memory. In step F, 536, when the user operating set top box 2 (unit 526 and TV 528) selects that particular good associated with the video asset, that new user at set top box 526 sees not only the goods video asset but also the consumer feedback 522 represented in step F, 536.

### Transactional System with Data Warehousing Feature, Data Tracking, Shopping Cart Reservation, Purchase Commentary and External Marketing Incentives Deployed on VOD

The Data Warehousing, Data Tracking, Shopping Cart Reservation, Purchase Commentary and External Marketing Incentive Process in General

The shop OD purchasing system can employ a data warehouse feature, including data tracking for prospective purchases such as an on-line shopping list, a shopping cart reservation feature, a purchase commentary, and in an enhanced embodiment, an external marketing incentive system. In one embodiment, the shop OD purchasing system is linked to supplement communications (supple-comm) networks or channels including cellular telephone communications network, a VoIP communications network, a terrestrial telephone network and the Internet. Goods or services are advertised upon command to the user-viewer via his or her interactive television set (STB enabled TV) and a cable head end. The user-viewer is enrolled into the Shop OD purchasing program as discussed above or the user may enroll via the supplemental communications channels into the shop OD program. The purchasing method gathers prospective orders for specific goods or services as a shopping list on the Shop on-demand computer server employing at least one, or several, supplemental communications channels such as the cell phone network, VoIP, land line telephone and Internet. The purchasing system effects the display of the shopping list on the user's interactive television set. This is accomplished by sending a shopping formative signal from the group of formative signals including VOD menu metadata, VOD asset metadata, VOD asset from the cable head end and a VOD asset from the shop on-demand client application operative at the cable head end. In other words, the shopping list for specific prospective goods or services can be compiled on line or can be compiled via the Shop OD-VOD system and then displayed with the appropriate signals streamed or downloaded to the user's interactive TV as part of a metadata or streaming VOD assets.

To further incentivised the purchase of goods and services, the Shop OD computer server locates complementary goods or services associated with specific goods or services on the user's shopping list. The Shop OD computer server generates complementary advertisements for this complementary goods or services and directs those complementary advertisements to the enrolled user-viewer associated with the shopping list. The purchasing method then employs one or both of either displaying the complementary advertisements on the interactive television set of the user or transmitting representative complementary advertisements to the user via the supplemental communications channels. If the complementary advertisements are streamed to the user's interactive television set, formative signals such as VOD menu metadata, VOD asset metadata, VOD asset from the cable head end or VOD asset from the shop on-demand client application is sent to the interactive TV. The complementary advertisements can be sent to the user via the supplemental communications channels. Clearly, the supplemental communications channels can be linked and prioritized as discussed above in connection with the user enrollment system and process.

The purchasing shopping list can also be established via the Shop OD purchasing system and process. The system can transmit, upon command of the user-viewer a signal representative of a prospective order for specific goods or services after selection of the advertised goods or services. This representative signal is sent to either the cable head end or the shop on-demand client application. The prospective order signal corresponds to the prospective goods or services and the associated set ID code for the user's interactive television set. At the Shop OD computer server, a compilation of the prospective order signal and prospective specific goods or services and associated set ID code are compiled into the user's profile data and specifically the on-line shopping list. The Shop OD process then effects a display of the shopping list and the prospective specific goods or services via a shopping list formative signal which includes menu metadata, asset metadata and VOD asset from either the cable head end or the Shop OD client application. To “effect the display,” the Shop OD process transmits signals or streams a VA signal to the user's STB (interactive TV) and thereat displays the shopping list and prospective specific goods or services. As indicated earlier, the user may supplement his or her on-line shopping list via the supplemental communications channels. Supplemental prospective orders for these specific goods or services from the supplemental communications channels cause the display of the shopping list and the prospective specific goods from the supplemental shopping list as described above.

A merchandising and purchasing program enables the use of external market incentives to generate orders on the Shop OD purchasing system. The Shop OD computer server generates merchandising incentive for promoted goods or services via at least one of the supplemental communications channels which includes cellular telephone, VoIP, terrestrial telephone network and the Internet. These merchandising incentives are sent to enrolled user-viewers. Merchandising incentive include at least one from discount for promoted goods or services, time limited offers to sell promoted goods or services, limited inventories of promoted goods or services and special sales of promoted goods or services. Upon command of the user-viewer at the interactive television set, the promoted goods or services are advertised. In response to a buy-now command by the user-viewer for the specific promoted goods a transaction code is generated with an algorithm correlated to the set ID code and the specific promoted goods or services. At the Shop OD computer server, a report of the merchandising effort is made based upon the transaction ID code and is sent to a vendor or vendor-authorized agent.

More specifically, the transaction ID code and the specific promoted goods or services can be sent from the cable head end down to the interactive television as a formative signal from the group of VOD menu metadata, VOD asset metadata, VOD asset from the cable head end and VOD asset from the shop on-demand client application. Alternatively, the transaction ID code can be generated at the interactive television set (STB) and uploaded to the cable head end or to the shop on-demand client application.

### Details of the Data Warehousing, Data Tracking, Shopping Cart Reservation, Purchase Commentary and External Marketing Incentive Process

In summary, transactional system uses a data tracker to keep a record of all (or at least the last 10 (or xx number) of Shop OD purchases by a particular purchaser/user and, in an enhanced system, provides a shopping cart feature or a “wish list” of prospective purchases that the user/subscriber may want to purchase later. The wish list of prospective products which the user has previewed but has not yet decided to buy may be supplemented by targeted marketing efforts to sell similar or complementary goods/services. This data tracker, account management, wish list information is formed as a singular video asset and each purchase may be a chapter per the Guide Directory chaptered video asset technology. Other types of Guide Directory linked video asset player—chaptering methodology may be employed. The user can go through and look at each purchase and/or select the goods from the shopping cart to complete the buy. With the addition of matching a user's profile, voluntarily provided by the user during enrollment or during as “change profile” routine, the system may add display format/windows and new textual data and VAs which are of interest to the user, all without the user's intervention.

See U.S. Pat. No. 5,892,536 and U.S. Pat. No. 6,931,451 for chapter indexing system.

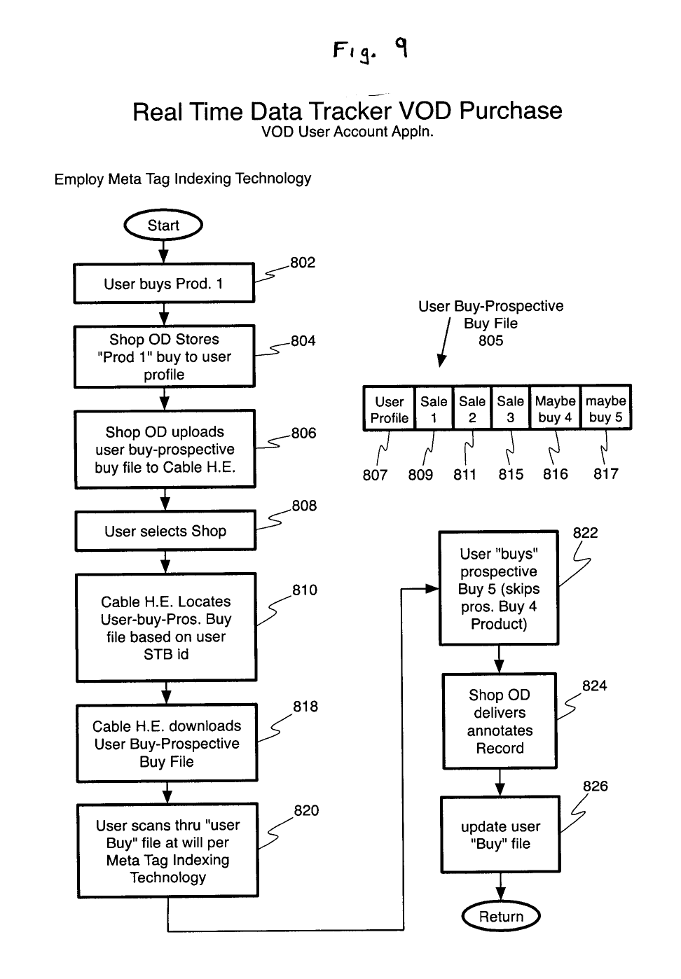

FIG. 9 shows a real time data tracker for video on demand purchase. This video on demand and user account application employs Guide Directory linked video asset player-chaptering sub-system or the meta tag-indexing technology explained herein.

In step 802, the user selects and buys product 1. In step 804, the Shop OD computer system stores product ID information for product 1 in the user profile. Unit 805 shows the user “Buy-prospective buy” file. The user file may be part of the Shop OD Guide Directory forwarded and stored in the STB upon power-up or during the course of navigating the VOD menus. If in the GD, the user file is linked to a VA for the goods. This user file starts with a user profile 807 and product sale 1 at memory 809, product sale 2 at memory 811, product sale 3 at memory 815, prospective buy goods file 4 at memory element 816 and prospective buy goods 5 at memory element 817. In a GD environment, the GD has dated branches. The GD-L shown in the user buy-prospective buy file 805 utilizes meta tag indexing technology such that the chapter markers (or GD-L) are provided between memory elements 807, 809, 811, 815, 816 and 817. Therefore, the user, if the GD-L were downloaded to the set top box, could process through his or her past purchases and prospective purchases without much difficulty. This is an account management feature. The prospective buy data is a wish list file. Other files, different than the chaptered and indexed VA file, may be employed. Since the account data is textual/numerical, this data can be transmitted quickly and stored in nominal memory locations. In an enhanced system, the user may also download the user's profile to the STB for review and or confirmation. If the user wants to change his or her profile, selecting a navigational button on the GD activates a call back or external communication session between the user and the Shop OD system. The session permits the user to re-set his or her profile.

In step 806, the Shop OD computer system uploads the buy-prospective buy file (wish list) to the cable head end. This happens periodically, preferably one or more times per day. In step 808, the user selects the Shop OD button. In step 810, the cable head end locates the user buy-prospective buy file 805 based upon the user set top ID. In step 818, the cable head end downloads the user buy-prospective buy file (maybe GD-L) to the set top box. In step 820, the user scans the user buy-prospective buy file (wish list) at will using the chapter to chapter indexing system of the meta tag indexing technology to review the VOD menus for available VOD assets. In step 822, the user selects buy-prospective buy product 5 thereby skipping prospective buy product 4. These items are shown in memory element 816, 817 in the user buy-prospective buy file 805. In step 824, the Shop OD computer system delivers the goods ordered by the customer corresponding to product 5 in file sub unit 817. Also, the Shop OD system updates the user buy-prospective buy file 805 indicating that the user has purchased product 5 in memory slot 817. In the GD-L format, this updates all the Shop OD guide directories. In step 826, the user's file is updated. The system then returns and continually updates the video asset for the user file.

Of course, the user may visit the shopod.com website and re-set the user's profile, thereby enabling further targeted marketing efforts. Additional targeting marketing with call centers, text sms cell phone messaging, targeted email broadcasts from the Shop OD system is contemplated.

### External or Internal Marketing Incentives with Electronic Delivery Systems Redeemable by Shop on Demand System

A coupon or market incentive discount delivery and redemption system may be added to the various systems and methods discussed herein. A coupon (or other type of discount marker or give away or supplemental good or service chit) can be (a) delivered to the Shop OD customer during a video on demand shopping experience or (b) delivered via cell phone or mobile computer (pda) or (c) delivered via email as an incentive to buy more goods/services or to spur the customer to buy complementary goods/services associated with the Shop OD purchase. The electronic coupon, delivered as a text sms message or IVR notice to the cell phone user can be redeemed at various retailers. The user may be required to visit the Shop OD website and print out the coupon, or the retailer may accept an electronic coupon. After presentment by the user, the retailer then presents the Shop OD system computer—administrator with the coupon and receives whatever compensation previously designated by the Shop OD program.

The claims appended hereto are meant to cover modifications and changes within the scope and spirit of the present invention.

What is claimed is:

1. An inventory tracking and purchasing method permitting a user-viewer to participate in a purchasing program for goods and services via a user-viewer's interactive television set communicatively coupled via a cable system network to a cable head end which is communicatively coupled via a communications network to a shop on-demand computer server comprising:
advertising said goods or services upon command of said user-viewer via said interactive television set and said cable head end;
transmitting an inventory sales indicator as an inventory formative signal from the group of inventory formative signals including video on demand (VOD) menu metadata, VOD asset metadata, a VOD asset from said cable head end and a VOD asset from a shop on-demand client application operative at said cable head end; and
effecting the display of inventory scarcity indicia in conjunction with advertising said goods or services on said interactive television set based upon said inventory formative signal.

2. An inventory tracking and purchasing method as claimed in claim 1 wherein said inventory sales indicator is associated with a plurality of tracked goods or services, each tracked good or service of said plurality of tracked goods or services being associated with a corresponding inventory sales indicator in said shop on-demand computer server, said shop on-demand computer server updating the corresponding inventory sales indicator for associated tracked goods or services based upon vendor-supplied data therefor.

3. An inventory tracking and purchasing method as claimed in claim 2 wherein said shop on-demand computer server generates the updated corresponding inventory sales indicator for associated tracked goods or services and transmits said updated corresponding inventory sales indicator to either said cable head end or said shop on-demand client application operative at said cable head end, as a precursor to said inventory formative signal for the associated tracked goods or services.

4. An inventory tracking and purchasing method as claimed in claim 3 wherein said updated inventory sales indicator and corresponding inventory formative signal for the associated tracked goods or services is indicative of one of an actual or fictitious inventory level from the group of actual or fictitious inventory levels for said associated tracked goods or services including low inventory level, sold out inventory level, inventory levels available for a predetermined period of time and inventory level available at a discounted price.

5. An inventory tracking and purchasing method as claimed in claim 1 wherein said inventory sales indicator is associated with a plurality of tracked goods or services and said inventory scarcity indicia represents a time countdown which limits the availability of respective ones of said plurality of tracked goods or services.

6. An inventory tracking and purchasing method as claimed in claim 5 wherein said time countdown is based upon a time formative signal from the group of time formative signals including VOD menu metadata, VOD asset metadata, VOD asset from said cable head end and VOD asset from said shop on-demand client application operative at said cable head end.

7. An inventory tracking and purchasing method as claimed in claim 5 wherein said time countdown is based upon a time clock in said interactive television set.

8. An inventory tracking and purchasing method as claimed in claim 6 wherein said time countdown is based upon said time formative signal from the sub-group of time formative signals including a VOD asset from said cable head end which simulates a time countdown and VOD asset from said shop on-demand client application which simulates a time countdown.

9. A merchandising incentive and purchasing method permitting a user-viewer to participate in a purchasing program for goods and services via a user-viewer's interactive television set communicatively coupled via a cable system network to a cable head end which is communicatively coupled via a communications network to a shop on-demand computer server comprising:
advertising said goods or services upon command of said user-viewer via said interactive television set and said cable head end;
generating inventory scarcity indicia representing a time countdown in conjunction with that advertising of said goods or services and effecting the display of said inventory scarcity time countdown indicia on said interactive television set;
said inventory scarcity time countdown indicia based upon either clock signals from said interactive television set or based upon an inventory countdown indicator as an inventory formative signal from the group of inventory formative signals including video on demand (VOD) menu metadata, VOD asset metadata, VOD asset from said cable head end and VOD asset from said shop on-demand client application operative at said cable head end.

10. A merchandising incentive and purchasing method as claimed in claim 9 wherein said said inventory scarcity time countdown indicia is based upon said inventory countdown indicator sent as said inventory formative signal from said cable head end and is associated with a plurality of tracked goods or services monitored at said shop on-demand computer server.

11. A merchandising incentive and purchasing method as claimed in claim 10 wherein said inventory scarcity time countdown indicia is further associated with a discount coupon for respective tracked goods or services, said discount coupon
advertised with said tracked goods or services upon command of said user-viewer via said interactive television set;
said discount coupon based upon a discount indicator as a discount formative signal from the group of discount formative signals including video on demand (VOD) menu metadata, VOD asset metadata, VOD asset from said cable head end and VOD asset from said shop on-demand client application operative at said cable head end.

12. A merchandising incentive and purchasing method permitting a user-viewer to participate in a purchasing program for goods and services via a user-viewer's interactive television set communicatively coupled via a cable system network to a cable head end which is communicatively coupled via a communications network to a shop on-demand computer server comprising:
advertising said goods or services upon command of said user-viewer via said interactive television set and said cable head end;
generating a discount coupon indicia representing a discounted price in conjunction with that advertising of said goods or services and effecting the display of said discount coupon indicia on said interactive television set;
said discount coupon indicia based upon a discount indicator as a discount formative signal from the group of discount formative signals including video on demand (VOD) menu metadata and VOD asset metadata.

13. A merchandising incentive and purchasing method as claimed in claim 12 wherein said said discount coupon indicia is associated with a plurality of tracked goods or services monitored at said shop on-demand computer server.
